(19) United States
(12) Patent Application Publication
(10) Pub. No.: US 2005/0203257 A1
(43) Pub. Date: Sep. 15, 2005

(54) Resin composition, and optical component, plastic lens and plastic film substrate utilizing the same

(75) Inventors: Osamu Uchida, Minami-ashigara-shi (JP); Tetsufumi Takamoto, Minami-ashigara-shi (JP)

Correspondence Address: BUCHANAN INGERSOLL PC;(INCLUDING BURNS, DOANE, SWECKER & MATHIS), POST OFFICE BOX 1404, ALEXANDRIA, VA, 22313-1404, US

(73) Assignee: Fuji Photo Film Co., Ltd., Minami-ashigara-shi (JP)

(21) Appl. No.: 11/056,358

(22) Filed: Feb. 14, 2005

(30) Foreign Application Priority Data
Feb. 13, 2004 (JP) 2004-036735

(51) Int. Cl. C08G 63/02

(52) U.S. Cl. 525/437

(57) ABSTRACT

A resin composition containing a polymer comprising a chemical structure represented by the following formula (1) in a main chain of the polymer: 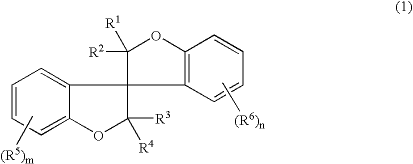
wherein, in the formula (1), R¹ to R⁴ independently represent hydrogen atom or a substituent, R⁵ and R⁶ independently represent a substituent, m and n represent an integer of 0 to 4, and when m and/or n is 2 or larger, R⁵ and/or R⁶ may be the same or different, and R⁵ or R⁶ may bond to each other to form a 5- to 7-membered ring, which has superior heat resistance, optical characteristics and mechanical characteristics, as well as a plastic film substrate utilizing the resin composition, a transparent conductive film substrate and flat panel display utilizing the plastic film substrate.

### BACKGROUND OF THE INVENTION

1. Field of the Invention

The present invention relates to a resin composition containing a polymer having a particular chemical structural formula as well as an optical component, plastic film substrate, image display device and flat panel display utilizing the same.

More precisely, the present invention relates to a resin composition as well as optical components such as transparent conductive film substrate, TFT substrate, substrate for liquid crystal display, substrate for organic EL display, substrate for electronic paper, substrate for solar battery, optical disk substrate, optical waveguide, optical fiber, lens and touch panel, plastic film substrate, image display device and flat panel display, which have superior heat resistance, optical characteristics, mechanical characteristics etc.

2. Description of the Related Art

Inorganic glass materials show superior transparency, superior heat resistance and small optical anisotropy, and therefore they are widely used as transparent materials. However, because inorganic glass has a large specific gravity and is brittle, molded grass products have drawbacks that they are heavy, likely to break etc. Due to these drawbacks, development of plastic materials replacing inorganic glass materials is actively done in recent years.

As plastic materials aiming at replacement of such inorganic glass materials, for example, polymethyl methacrylates, polycarbonates, polyethylene terephthalates and so forth are known. Because these plastic materials have lightweight and superior mechanical characteristics and show superior workability, they are recently used for various purposes such as lenses and films.

Further, in the field of flat panel displays such as liquid crystal displays, improvement of damage resistance, lighter weight and smaller thickness have been increasingly needed, and replacement of glass substrates with plastic film substrates is studied. Because plastic film substrates can be flexible substrates, and therefore they can be used as substrates of display devices for mobile information communication equipments such as cellular phones and portable information terminals such as electronic notes and laptop personal computers, plastic film substrates are highly needed.

As heat resistant plastics used for the aforementioned purposes, for example, heat resistant amorphous polymers such as modified polycarbonates (modified PC), polyether sulphones (PES) and cycloolefin copolymers are hitherto known. However, there is a problem that sufficient heat resistance for plastic film substrates cannot be obtained even if these heat resistant plastics are used.

Furthermore, conventional plastics have a problem that they are inferior to glass in optical characteristics, i.e., when they are molded into a film shape, they causes birefringence due to molecular orientation depending on film formation conditions and optical elasticity coefficient peculiar to each resin, and it causes marked degradation of display quality in display devices such as coloration of displayed images and reduction of contrast. Therefore, plastic film substrates have been desired to have both of higher optically isotropic characteristics and higher heat resistance.

As techniques for solving the aforementioned problems of plastics concerning optical characteristics, low birefringence polycarbonate resins utilizing a spiro compound such as spirobiindanediol have been developed so far. See, for example, claims of Japanese Patent Laid-open Publication (Kokai) No. 63-314235. However, these polycarbonate resins have markedly inferior mechanical characteristics, and plastic film substrates obtained by molding them are brittle and have problems for practical use when they are used as optical components.

Furthermore, as techniques for improving the mechanical characteristics as the drawback of the aforementioned plastic materials utilizing spirobiindane, copolymerized polycarbonates utilizing spirobiindane introduced with ethyleneoxy bridging groups (see, for example, claims and paragraph [0005] of Japanese Patent Laid-open Publication No. 11-263833), copolymerized polycarbonates containing a particular diol constituent (see, for example, claims and paragraph [0007] of Japanese Patent Laid-open Publication No. 2000-281888) and so forth have been developed so far. However, even these polycarbonates are still insufficient in mechanical characteristics, and they have problems of degradation of optical characteristics, reduction of heat resistance and so forth.

Therefore, a plastic material that solves the problems of the plastic materials proposed so far and has superior heat resistance and fully satisfactory mechanical characteristics and optical characteristics has been strongly desired.

### SUMMARY OF THE INVENTION

The present invention is achieved in order to solve the problems of the conventional plastic materials, and the first object of the present invention is to provide a resin composition having superior heat resistance, optical characteristics and mechanical characteristics. The second object of the present invention is to provide a plastic film substrate utilizing such a resin composition as well as optical components such as transparent conductive film substrate, TFT substrate, substrate for liquid crystal display, substrate for organic EL display, substrate for electronic paper, substrate for solar battery, optical disk substrate, optical waveguide, optical fiber, lens and touch panel and flat panel display utilizing such a plastic film substrate.

The inventors of the present invention conducted various researches in order to solve the aforementioned problems, and as a result, they found that the aforementioned problems could be solved by a resin composition containing a polymer comprising a chemical structure represented by the following formula (1) in a main chain of the polymer, and it satisfied all of the desired heat resistance, optical characteristics, mechanical characteristics and so forth. Thus, they accomplished the present invention.

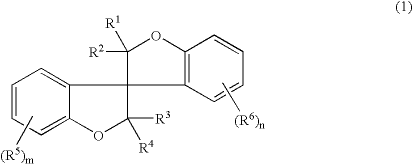

In the formula (1), R¹ to R⁴ independently represent hydrogen atom or a substituent, R⁵ and R⁶ independently represent a substituent, and m and n represent an integer of 0 to 4. When m and/or n is 2 or larger, R⁵ and/or R⁶ may be the same or different, and R⁵ or R⁶ may bond to each other to form a 5- to 7-membered ring.

Further, the object of the present invention can also be achieved by the resin composition containing a polymer comprising a repeating structural unit represented by the following formula (2).

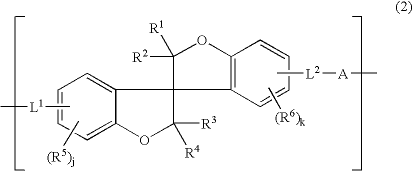

In the formula (2), R¹ to R⁴ independently represent hydrogen atom or a substituent, and R⁵ and R⁶ independently represent a substituent. L¹ and L² represent a single bond or a divalent bridging group, and j and k represent an integer of 0 to 3. When j and/or k is 2 or larger, R⁵ and/or R⁶ may be the same or different, and R⁵ or R⁶ may bond to each other to form a 5- to 7-membered ring. Further, L¹ and R⁵ and/or L² and R⁶ may bond to each other to form a 5- to 7-membered ring. A is at least one kind of group selected from divalent bridging groups represented by the formulas (3) to (9).

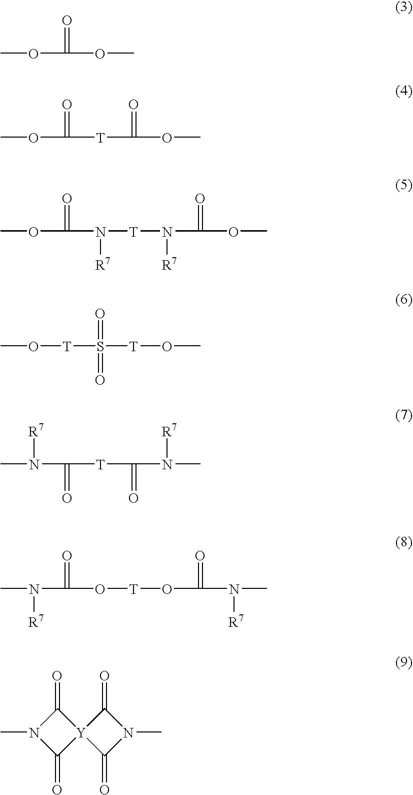

In the formulas (3) to (9), T represents a divalent organic group, and Y represents a tetravalent organic group. R⁷ independently represents hydrogen atom or a substituent, and two of R⁷ may bond to each other to form a ring. Further, the polymer may contain two or more kinds of different repeating units represented by the formula (2).

The resin composition of the present invention is preferably a resin composition containing the polymer further comprising a repeating unit represented by the following formula (10). [symbol]
B-A [symbol] (10)

In the formula (10), A represents at least one kind of group selected from divalent bridging groups represented by the aforementioned formulas (3) to (9), B represents a divalent organic group, and molar percentage q of the repeating structural units represented by formula (10) relative to the total molar number of the repeating structural units represented by formula (2) and the formula (10) satisfies the equation of 0<q<=50 mol %.

In the resin composition of the present invention, R¹ to R⁴ in the formula (1) and (2) preferably represent hydrogen atom. In the resin composition of the present invention, L¹ and L² in the formula (2) preferably represent a single bond. The resin composition of the present invention preferably has a glass transition temperature (referred to as “Tg” hereinafter) of 200° C. or higher. The polymer contained in the resin composition of the present invention is preferably one kind of resin selected from the group consisting of polycarbonate resins, polyester resins, polyarylate resins, polyester carbonate resins, polysulfone resins, polyurethane resins, polyamide resins, polyimide resins and polyamidimide resins.

The second object of the present invention is achieved by an optical component and plastic film substrate utilizing the aforementioned resin composition as well as a transparent conductive film substrate utilizing the plastic film substrate and a flat panel display utilizing the transparent conductive film substrate, preferably such a flat panel display comprising a liquid crystal panel or organic EL panel as a display device.

The resin composition of the present invention comprises a polymer containing a repeating unit derived from a compound represented by the aforementioned formula (1) or a repeating unit represented by any one of the aforementioned formulas (2) to (10). Because of this characteristic, the present invention can provide a resin composition having all of superior heat resistance, superior optical characteristics and superior mechanical characteristics.

Further, for the optical component, plastic film substrate, transparent conductive film substrate and flat panel display of the present invention, the resin composition of the present invention is utilized. Because of this characteristic, the present invention can provide an optical component and plastic film substrate having all of superior heat resistance, optical characteristics and mechanical characteristics, in particular, a transparent conductive film substrate for display device and flat panel display that do not show reduction of conductivity and have superior mechanical characteristics even after a mechanical stress is applied after film formation of the transparent conductive film or an oriented film, gas barrier film or the like is provided.

### BEST MODE FOR CARRYING OUT THE INVENTION

Hereafter, the resin composition, plastic substrate, transparent conductive film substrate and flat panel display of the present invention will be explained in detail.

The ranges expressed with “to” in the present specification mean ranges including the numerical values indicated before and after “to” as a lower limit value and upper limit value.

[Resin Composition]

The resin composition of the present invention contains a resin consisting of a polymer containing a chemical structure represented by the following formula (1) in a main chain of the polymer.

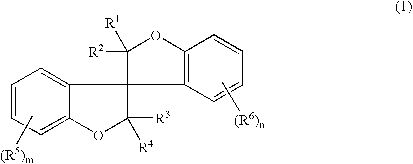

In the present specification, the expression “a polymer containing a chemical structure represented by the formula (1) in a main chain of the polymer” means that two parts of the main chain of the polymer bond to the chemical structure represented by the formula (1) at arbitrary two of positions from which two of hydrogen atoms are removed. Although the positions in the chemical structure represented by the formula (1) to which the parts of the main chain of the polymer are bonded are not particularly limited, the parts of the main chain preferably bond to different aromatic groups.

In the formula (1), R¹ to R⁴ independently represent hydrogen atom or a substituent. Preferred examples of the substituent include a halogen atom (e.g., fluorine atom, chlorine atom, bromine atom, iodine atom), an alkyl group (preferably, an alkyl group having 1 to 30 carbon atoms, e.g., methyl group, ethyl group, n-propyl group, isopropyl group, t-butyl group, n-octyl group, 2-ethylhexyl group etc.), a cycloalkyl group (preferably, a substituted or unsubstituted cycloalkyl group having 3 to 30 carbon atoms, e.g., cyclohexyl group, cyclopentyl group, 4-n-dodecylcyclohexyl group etc.), a bicycloalkyl group (preferably, a substituted or unsubstituted bicycloalkyl group having 5 to 30 carbon atoms, e.g., bicyclo[1,2,2]heptan-2-yl group, bicyclo[2,2,2]octan-3-yl group etc.), an alkenyl group (preferably, a substituted or unsubstituted alkenyl group having 2 to 30 carbon atoms, e.g., vinyl group, allyl group etc.), a cycloalkenyl group (preferably, a substituted or unsubstituted cycloalkenyl group having 3 to 30 carbon atoms, e.g., 2-cyclopenten-1-yl group, 2-cyclohexen-1-yl group etc.), a bicycloalkenyl group (a substituted or unsubstituted bicycloalkenyl group, preferably, a substituted or unsubstituted bicycloalkenyl group having 5 to 30 carbon atoms, e.g., bicyclo[2,2,1]hept-2-en-1-yl, bicyclo[2,2,2]oct-2-en-4-yl group etc.), an alkynyl group (preferably, a substituted or unsubstituted alkynyl group having 2 to 30 carbon atoms, e.g., ethynyl group, propargyl group), an aryl group (preferably, a substituted or unsubstituted aryl group having 6 to 30 carbon atoms, e.g., phenyl group, p-tolyl group, naphthyl group etc.), a heterocyclic group (preferably, a monovalent group obtained by removing one hydrogen atom from an aromatic or non-aromatic substituted or unsubstituted 5- or 6-membered heterocyclic compound, more preferably a 5- or 6-membered aromatic heterocyclic group having 3 to 30 carbon atoms, e.g., 2-furyl group, 2-thienyl group, 2-pyrimidinyl group, 2-benzothiazolyl group etc.), cyano group, hydroxyl group, nitro group, carboxyl group, an alkoxyl group (preferably, a substituted or unsubstituted alkoxyl group having 1 to 30 carbon atoms, e.g., methoxy group, ethoxy group, isopropoxy group, t-butoxy group, n-octyloxy group, 2-methoxyethoxy group etc.), an aryloxy group (preferably, a substituted or unsubstituted aryloxy group having 6 to 30 carbon atoms, e.g., phenoxy group, 2-methylphenoxy group, 4-t-butylphenoxy group, 3-nitrophenoxy group, 2-tetradecanoylaminophenoxy group), a silyloxy group (preferably, a silyloxy group having 3 to 20 carbon atoms, e.g., trimethylsilyloxy group, t-butyldimethylsilyloxy group), a heterocyclyloxy group (preferably, a substituted or unsubstituted heterocyclyloxy group having 2 to 30 carbon atoms, e.g., 1-phenyltetrazole-5-oxy group, 2-tetrahydropyranyloxy group etc.), an acyloxy group (preferably, formyloxy group, a substituted or unsubstituted alkylcarbonyloxy group having 2 to 30 carbon atoms or a substituted or unsubstituted arylcarbonyloxy group having 6 to 30 carbon atoms, e.g., formyloxy group, acetyloxy group, pivaloyloxy group, stearoyloxy group, benzoyloxy group, p-methoxyphenylcarbonyloxy group), a carbamoyloxy group (preferably, a substituted or unsubstituted carbamoyloxy group having 1 to 30 carbon atoms, e.g., N,N-dimethylcarbamoyloxy group, N,N-diethylcarbamoyloxy group, morpholinocarbonyloxy group, N,N-di-n-octylaminocarbonyloxy group, N-n-octylcarbamoyloxy group), an alkoxycarbonyloxy group (preferably, a substituted or unsubstituted alkoxycarbonyloxy group having 2 to 30 carbon atoms, e.g., methoxycarbonyloxy group, ethoxycarbonyloxy group, t-butoxycarbonyloxy group, n-octylcarbonyloxy group), an aryloxycarbonyloxy group (preferably, a substituted or unsubstituted aryloxycarbonyloxy group having 7 to 30 carbon atoms, e.g., phenoxycarbonyloxy group, p-methoxyphenoxycarbonyloxy group, p-n-hexadecyloxyphenoxycarbonyloxy group), an amino group (preferably a substituted or unsubstituted alkylamino group having 1 to 30 carbon atoms or a substituted or unsubstituted anilino group having 6 to 30 carbon atoms, e.g., amino group, methylamino group, dimethylamino group, anilino group, N-methylanilino group, diphenylamino group), an acylamino group (preferably, formylamino group, a substituted or unsubstituted alkylcarbonylamino group having 1 to 30 carbon atoms or a substituted or unsubstituted arylcarbonylamino group having 6 to 30 carbon atoms, e.g., formylamino group, acetylamino group, pivaloylamino group, lauroylamino group, benzoylamino group etc.), an aminocarbonylamino group (preferably, a substituted or unsubstituted aminocarbonylamino group having 1 to 30 carbon atoms, e.g., carbamoylamino group, N,N-dimethylaminocarbonylamino group, N,N-diethylaminocarbonylamino group, morpholinocarbonylamino group etc.), an alkoxycarbonylamino group (preferably, a substituted or unsubstituted alkoxycarbonylamino group having 2 to 30 carbon atoms, e.g., methoxycarbonylamino group, ethoxycarbonylamino group, t-butoxycarbonylamino group, n-octadecyloxycarbonylamino group, N-methylmethoxycarbonylamino group etc.), an aryloxycarbonylamino group (preferably, a substituted or unsubstituted aryloxycarbonylamino group having 7 to 30 carbon atoms, e.g., phenoxycarbonylamino group, p-chlorophenoxycarbonylamino group, m-n-octyloxyphenoxycarbonylamino group etc.), a sulfamoylamino group (preferably, a substituted or unsubstituted sulfamoylamino group having 0 to 30 carbon atoms, e.g., sulfamoylamino group, N,N-dimethylaminosulfonylamino group, N-n-octylaminosulfonylamino group etc.), an alkyl- or arylsulfonylamino group (preferably, a substituted or unsubstituted alkylsulfonylamino group having 1 to 30 carbon atoms or a substituted or unsubstituted arylsulfonylamino group having 6 to 30 carbon atoms, e.g., methylsulfonylamino group, butylsulfonylamino group, phenylsulfonylamino group, 2,3,5-trichlorophenylsulfonylamino group, p-methylphenylsulfonylamino group etc.), mercapto group, an alkylthio group (preferably, a substituted or unsubstituted alkylthio group having 1 to 30 carbon atoms, e.g., methylthio group, ethylthio group, n-hexadecylthio group), an arylthio group (preferably, a substituted or unsubstituted arylthio group having 6 to 30 carbon atoms, e.g., phenylthio group, p-chlorophenylthio group, m-methoxyphenylthio group), a heterocyclylthio group (preferably, a substituted or unsubstituted heterocyclylthio group having 2 to 30 carbon atoms, e.g., 2-benzothiazolylthio group, 1-phenyltetrazol-5-ylthio group etc.), a sulfamoyl group (preferably, a substituted or unsubstituted sulfamoyl group having 0 to 30 carbon atoms, e.g., N-ethylsulfamoyl group, N-(3-dodecyloxypropyl)sulfamoyl group, N,N-dimethylsulfamoyl group, N-acetylsulfamoyl group, N-benzoylsulfamoyl group, N-(N′-phenylcarbamoyl)sulfamoyl group etc.), sulfo group, an alkyl- or arylsulfinyl group (preferably, a substituted or unsubstituted alkylsulfinyl group having 1 to 30 carbon atoms or a substituted or unsubstituted arylsulfinyl group having 6 to 30 carbon atoms, e.g., methylsulfinyl group, ethylsulfinyl group, phenylsulfinyl group, p-methylphenylsulfinyl group etc.), an alkyl- or arylsulfonyl group (preferably, a substituted or unsubstituted alkylsulfonyl group having 1 to 30 carbon atoms or a substituted or unsubstituted arylsulfonyl group having 6 to 30 carbon atoms, e.g., methylsulfonyl group, ethylsulfonyl group, phenylsulfonyl group, p-methylphenylsulfonyl group), an acyl group (preferably, formyl group, a substituted or unsubstituted alkylcarbonyl group having 2 to 30 carbon atoms or a substituted or unsubstituted arylcarbonyl group having 7 to 30 carbon atoms, e.g., acetyl group, pivaloylbenzoyl group etc.), an aryloxycarbonyl group (preferably, a substituted or unsubstituted aryloxycarbonyl group having 7 to 30 carbon atoms, e.g., phenoxycarbonyl group, o-chlorophenoxycarbonyl group, m-nitrophenoxycarbonyl group, p-t-butylphenoxycarbonyl group etc.), an alkoxycarbonyl group (preferably, a substituted or unsubstituted alkoxycarbonyl group having 2 to 30 carbon atoms, e.g., methoxycarbonyl group, ethoxycarbonyl group, t-butoxycarbonyl group, n-octadecyloxycarbonyl group), a carbamoyl group (preferably, a substituted or unsubstituted carbamoyl group having 1 to 30 carbon atoms, e.g., carbamoyl group, N-methylcarbamoyl group, N,N-dimethylcarbamoyl group, N,N-di-n-octylcarbamoyl group, N-(methylsulfonyl)carbamoyl group), an aryl- or heterocyclylazo group (preferably, a substituted or unsubstituted arylazo group having 6 to 30 carbon atoms or a substituted or unsubstituted heterocyclylazo group having 3 to 30 carbon atoms, e.g., phenylazo group, p-chlorophenylazo group, 5-ethylthio-1,3,4-thiadiazol-2-ylazo group), an imido group (preferably, N-succinimido group, N-phthalimido group), a phosphino group (preferably, a substituted or unsubstituted phosphino group having 2 to 30 carbon atoms, e.g., dimethylphosphino group, diphenylphosphino group, methylphenoxyphosphino group), a phosphinyl group (preferably, a substituted or unsubstituted phosphinyl group having 2 to 30 carbon atoms, e.g., phosphinyl group, dioctyloxyphosphinyl group, diethoxyphosphinyl group), a phosphinyloxy group (preferably, a substituted or unsubstituted phosphinyloxy group having 2 to 30 carbon atoms, e.g., diphenoxyphosphinyloxy, dioctyloxyphosphinyloxy), a phosphinylamino group (preferably, a substituted or unsubstituted phosphinylamino group having 2 to 30 carbon atoms, e.g., dimethoxyphosphinylamino group, dimethylaminophosphinylamino group), a silyl group (preferably, a substituted or unsubstituted silyl group having 3 to 30 carbon atoms, e.g., trimethylsilyl group, t-butyldimethylsilyl group, phenyldimethylsilyl group) and so forth.

When a hydrogen atom is contained in the aforementioned substituents, the hydrogen atom may further be substituted with any one of the aforementioned substituents. Examples of such substituents include an alkylcarbonylaminosulfonyl group, an arylcarbonylaminosulfonyl group, an alkylsulfonylaminocarbonyl group, an arylsulfonylaminocarbonyl group and so forth. More specifically, examples include methylsultonylaminocarbonyl group, p-methylphenylsulfonylaminocarbonyl group, acetylaminosulfonyl group, benzoylaminosulfonyl group and so forth.

Among the aforementioned substituents, hydrogen atom is particularly preferred as R¹ to R⁴.

In the formula (1), R⁵ and R⁶ independently represent a substituent, preferably any one of the examples of the substituent as R¹ to R⁴, more preferably at least one kind of group selected from the group consisting of a halogen atom, an alkyl group, an aryl group, carboxyl group, an alkoxyl group, an aryloxy group and an acylamino group.

In the formula (1), m and n represent an integer of 0 to 4, preferably 0 or 1. When m and/or n is 2 or larger, R⁵ and/or R⁶ may be the same or different, preferably the same. R⁵ and/or R⁶ may bond to each other to form a 5- to 7-membered ring, particularly preferably a 6-membered ring.

Synthesis examples of compounds having a chemical structure represented by the formula (1) will be shown below. 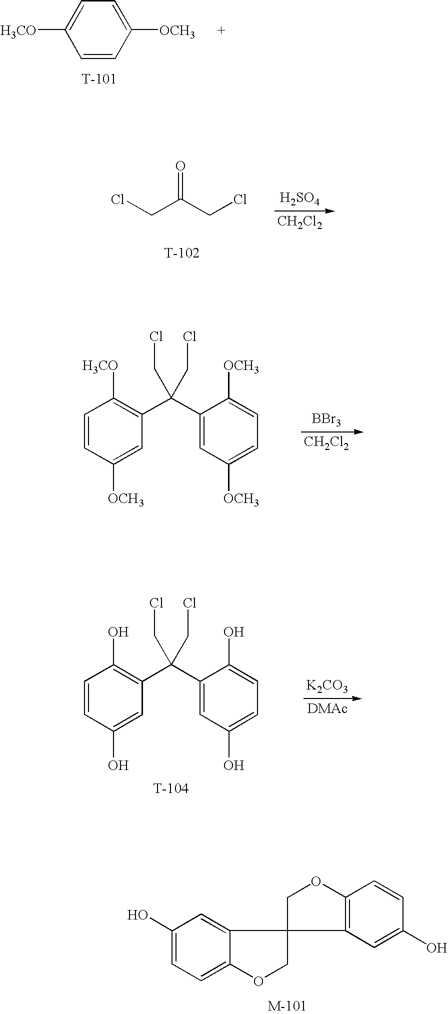
(1) Synthesis of Intermediate T-103

In an amount of 1.66 kg of hydroquinone dimethyl ether (T-101) and 1.5 L of methylene chloride were added to a 5 L-three-neck flask, and then the external temperature was set at 40° C. to allow temperature elevation. When the internal temperature became 35° C., T-101 was dissolved. At this time, 355 mL of concentrated sulfuric acid was added dropwise over 30 minutes, and then the external temperature was set at 50° C. Then, when the internal temperature became 45° C., it was started to add 1,3-dichloroacetone (T-102) dropwise. It took 40 minutes to add 381 g of T-102 dropwise, and during this period, the internal temperature rose to 50° C. After the reaction was allowed at 50° C. for further 4 hours, the reaction system was exposed to room temperature, and the concentrated sulfuric acid dissociated from the oil was separated by phase separation. The organic layer was concentrated under reduced pressure, and the residue was poured into 2 L of methanol. The precipitated crystals were taken by filtration and washed with 500 mL of methanol. Thus, 457 g of Intermediate T-103 was obtained as white crystals (yield: 39.6%).

(2) Synthesis of Compound M-104 (Monomer)

In an amount of 200 g of Intermediate T-103 and 600 mL of 1,2-dichloroethane were added to a 2 L-three-neck flask, and then the external temperature was set at 5° C. to cool the mixture. Then, 220 mL of BBr₃ was added dropwise so that the internal temperature should not exceed 15° C. It took 2 hours to add BBr₃ dropwise. After the reaction was allowed for further 12 hours, the reaction mixture was carefully poured into 2 kg of ice water. To this mixture, 500 mL of methylene chloride was added, and the phases were separated. The phases were separated 3 times by using 1 L of water for each time, and then the organic layer was dried over anhydrous magnesium sulfate and concentrated under reduced pressure to obtain Intermediate T-104 as a crude product. Because Intermediate T-104 is relatively instable, it is preferable to carry out the subsequent steps immediately after synthesis thereof.

(3) Synthesis of Compound M-101 (Monomer)

The whole amount of Intermediate T-104 obtained in the previous step was put into a 500 mL-three-neck flask, and 200 mL of DMAc (N,N-dimethylacetamide) was added and uniformly dissolved at room temperature. To this solution, 145 g of potassium carbonate divided into seven portions was added every 10 minutes. As a result of the addition, the temperature of the reaction mixture was elevated and reached 40° C. After the addition, the external temperature was set at 50° C., and the reaction was allowed for further 3 hours. Inorganic components were separated from the reaction system by filtration, and the reaction mixture was poured into 1.5 L of 1 mol/L hydrochloric acid. The precipitated crystals were taken by filtration and washed with 500 mL of distilled water. The obtained crude crystals were recrystallized from methanol/methylene chloride mixed solvent to obtain 57 g of the monomer M-101 as white crystals (yield: 43.8%).

The obtained M-101 showed the following NMR spectrum. ¹H-NMR (δ in CDCl₃): 4.45 (dd, 4H), 6.41 (d, 2H), 6.59 (dd, 2H), 6.69 (d, 2H), 8.93 (s, 2H)

The resin composition of the present invention comprises a polymer containing a chemical structure represented by the aforementioned formula (1) in a main chain of the polymer. The content of the structure represented by the aforementioned formula (1) contained in the resin composition is 20 to 100 weight %, preferably 30 to 100 weight %, more preferably 50 to 100 weight %, relative to the total weight of the resin composition.

Although type of the polymer constituting the resin composition of the present invention is not particularly limited, it is preferably at least one kind of polymer selected from the group consisting of polycarbonate, polyester, polyarylate, polyester carbonate, polysulfone, polyurethane, polyamide, polyimide and polyamidimide, further preferably at least one kind of polymer selected from the group consisting of polycarbonate, polyester, polyarylate and polyurethane.

The resin composition of the present invention may be a resin composition comprising a polymer containing a repeating structural unit represented by the following formula (2). The formula (2) will be explained hereafter.

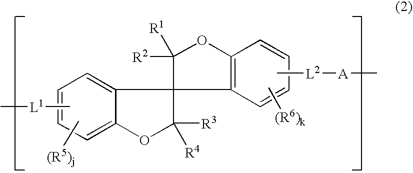

In the formula (2), R¹ to R⁶ have the same meanings as those of R¹ to R⁶ in the formula (1), respectively. Further, in the formula (2), L¹ and L² represent a single bond or a divalent bridging group, preferably a single bond. Example of the divalent bridging group include ether group, thioether group, imino group, carbonyl group, carbonyloxy group, oxycarbonyl group, carbonylimino group, iminocarbonyl group, sulfone group, a divalent saturated aliphatic hydrocarbon group, saturated alicyclic hydrocarbon group, aromatic hydrocarbon group, saturated heterocyclic group or unsaturated heterocyclic group having 40 or less carbon atoms and so forth, and these may have a substituent selected from those mentioned for R¹ to R⁴. Further, two or more bridging groups may bond to form one bridging group.

In the formula, j and k independently represent an integer of 0 to 3, preferably 0 to 2. When j and/or k is 2 or larger, R⁵ and/or R⁶ may be the same or different, and R⁵ and R⁶ preferably represent the same group. Further, R⁵ and/or R⁶ may bond to each other to form a 5- to 7-membered ring, preferably a 6-membered ring. Further, L¹ and R⁵ and/or L² and R⁶ may bond to each other to form a 5- to 7-membered ring, preferably a 6-membered ring. L¹ and L² preferably substitute the 5 and 5′ positions or 6 and 6′ positions.

In the formula (2), A represents at least one kind of group selected from divalent bridging groups represented by the aforementioned formulas (3) to (9). In the formulas (4) to (9), T represents a divalent organic group, and Y represents a tetravalent organic group. T is preferably a divalent saturated aliphatic hydrocarbon group, saturated alicyclic hydrocarbon group, aromatic hydrocarbon group, saturated heterocyclic group or unsaturated heterocyclic group having 40 or less carbon atoms, and these may have a substituent selected from those mentioned for R¹ to R⁴. Further, two or more bridging groups represented by L¹ and L² may bond to form one divalent bridging group.

R⁷ in the formulas (5) (7) (8) and (10) independently represents hydrogen atom or a substituent. Examples of the substituent include the same groups as those mentioned for R¹ to R⁴ in the formula (1). R⁷ is preferably hydrogen atom, an alkyl group or an aryl group.

Preferred examples of Y in the formula (9) include tetravalent saturated aliphatic hydrocarbon group, saturated alicyclic hydrocarbon group, aromatic hydrocarbon group, saturated heterocyclic group, unsaturated heterocyclic group and so forth having 40 or less carbon atoms, and these may have a substituent selected from those mentioned for R¹ to R⁴. It is preferred that the four bonding positions of this tetravalent bridging group (organic group) are divided into two sets of two positions, and two of bonding positions in each set exist on adjacent carbon atoms.

The content of the polymer containing a repeating structural unit represented by the aforementioned formula (2) in the resin composition of the present invention is 20 to 100 weight %, preferably 30 to 100 weight %, more preferably 50 to 100 weight %.

The polymer contained in the resin composition of the present invention may further contain a repeating structural unit represented by the following formula (10). [symbol]
B-A [symbol] (10)

In the formula (10), A represents at least one kind of group selected from divalent bridging groups represented by the formulas (3) to (9), and examples thereof include the same groups as the examples of the aforementioned divalent bridging group. B represents a divalent organic group, and preferred examples of B include the same groups as the examples of the aforementioned divalent organic group T.

The molar percentage q of the repeating structural units represented by formula (10) relative to the total repeating structural units of those represented by formula (2) and those represented by formula (10) satisfies the equation of 0<q<=50 mol %, preferably 0<q<=30 mol %, more preferably 0<q<=10 mol %, most preferably q=0 mol %.

The polymer may contain two or more kinds of the repeating structural units represented by the formulas (2) to (10).

Further, the content of the polymer containing the structural units represented by the formula (2) and the formula (10) in the resin composition of the present invention is 50 to 100 weight %, preferably 80 to 100 weight %, more preferably 90 to 100 weight %.

As the repeating unit represented by the formula (2) of the polymer contained in the resin composition of the present invention, those represented by the following structural formula (2′) are preferably used.

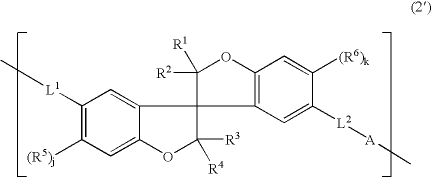

Specific examples of the repeating units represented by the formula (2) and (10) of the polymer contained in the resin composition of the present invention are mentioned below. However, the present invention is not limited to these.

<Examples of Repeating Units Represented by the Formula (2)>

In the examples mentioned below, A is arbitrarily selected from divalent bridging groups represented by the formulas (3) to (9). 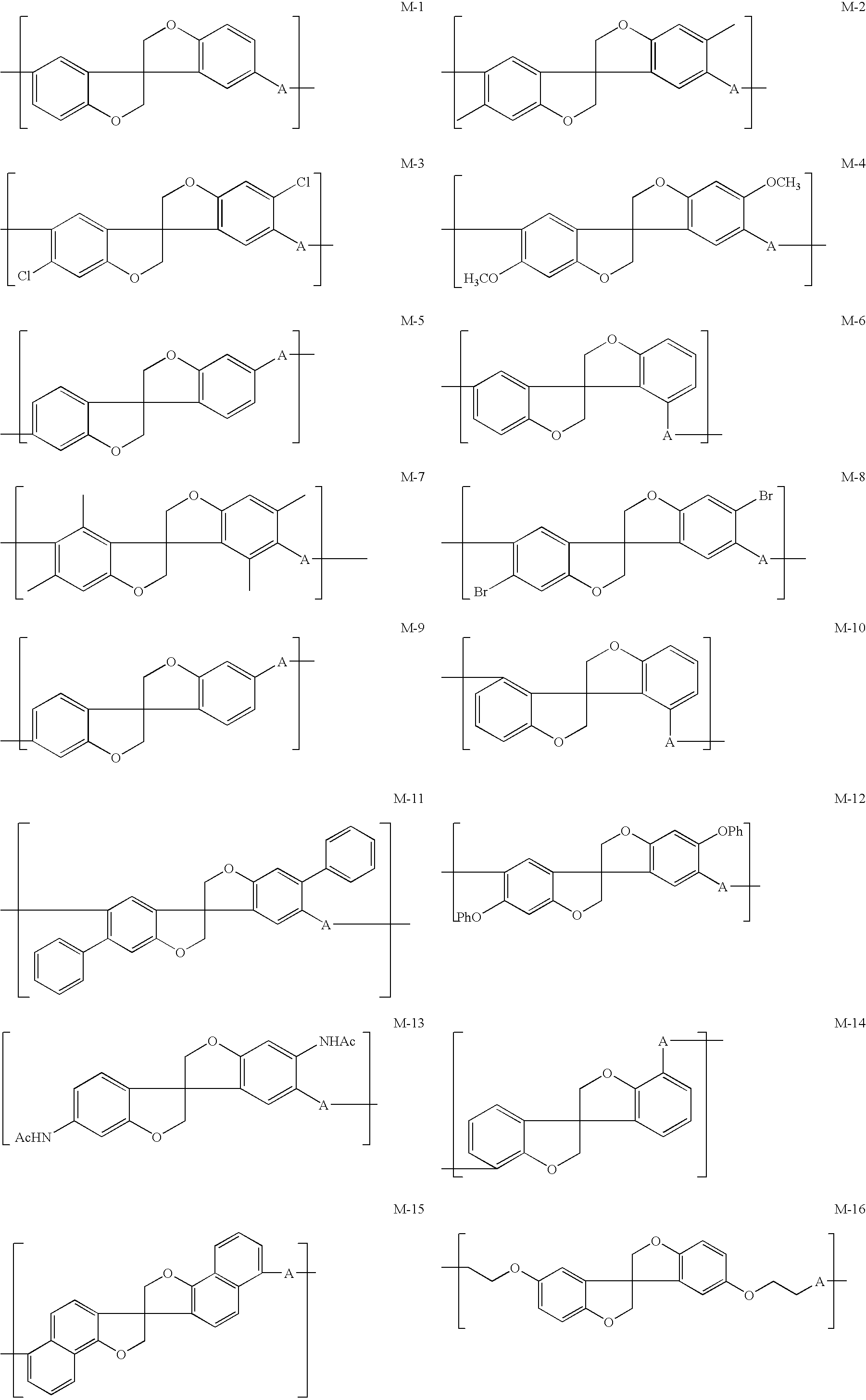 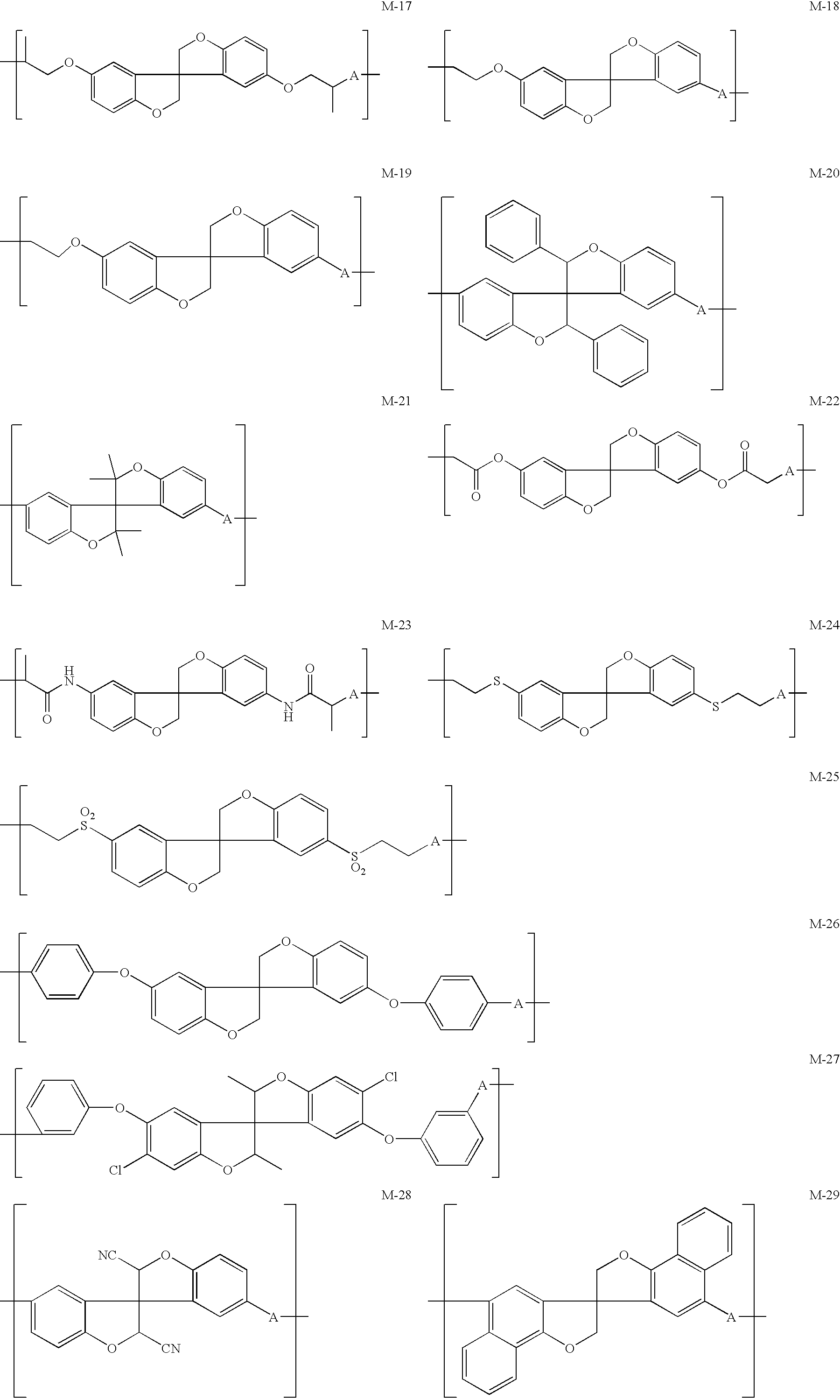
<Examples of Repeating Units Represented by the Formula (10)>

In the examples mentioned below, A is arbitrarily selected from divalent bridging groups represented by the formulas (3) to (9).

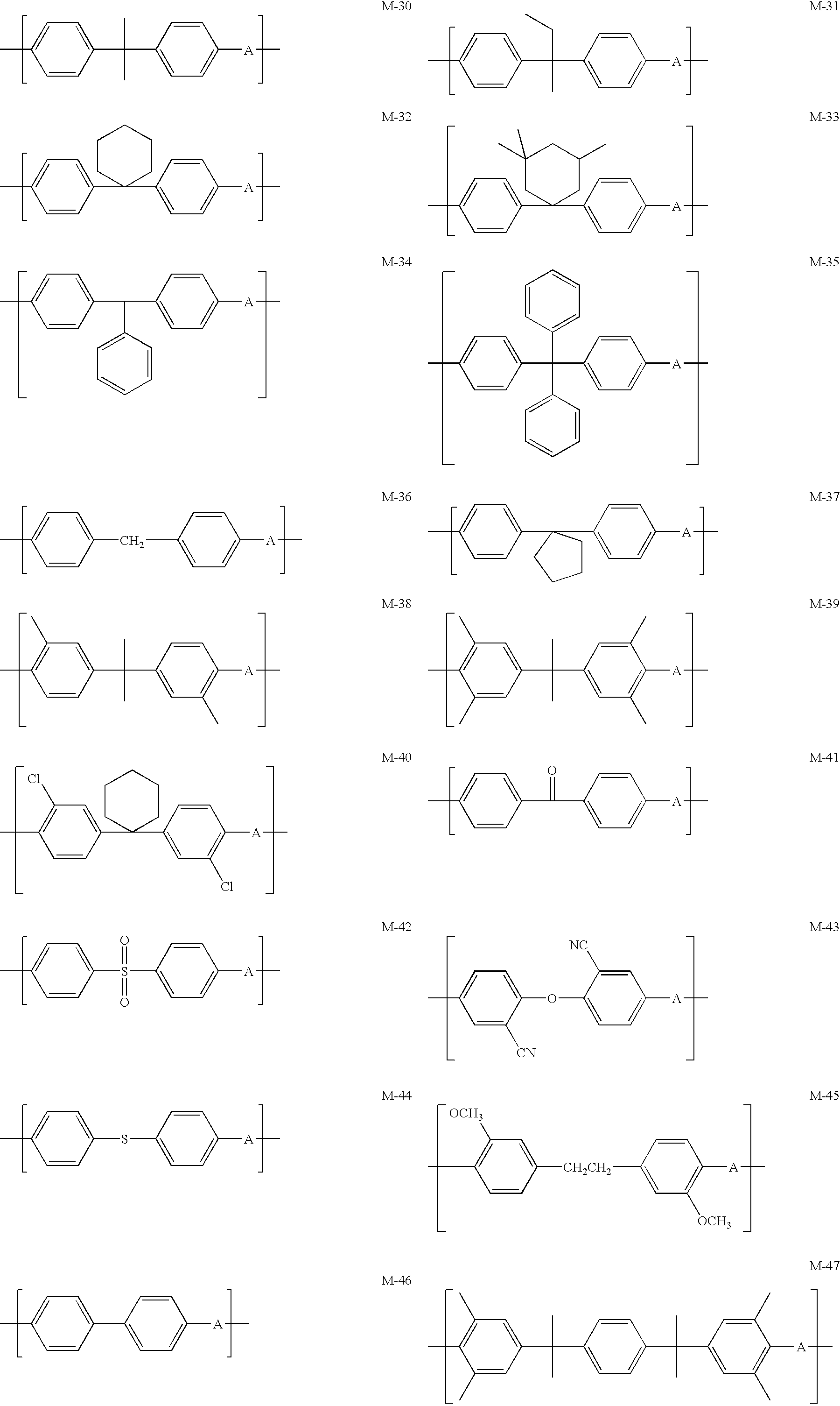

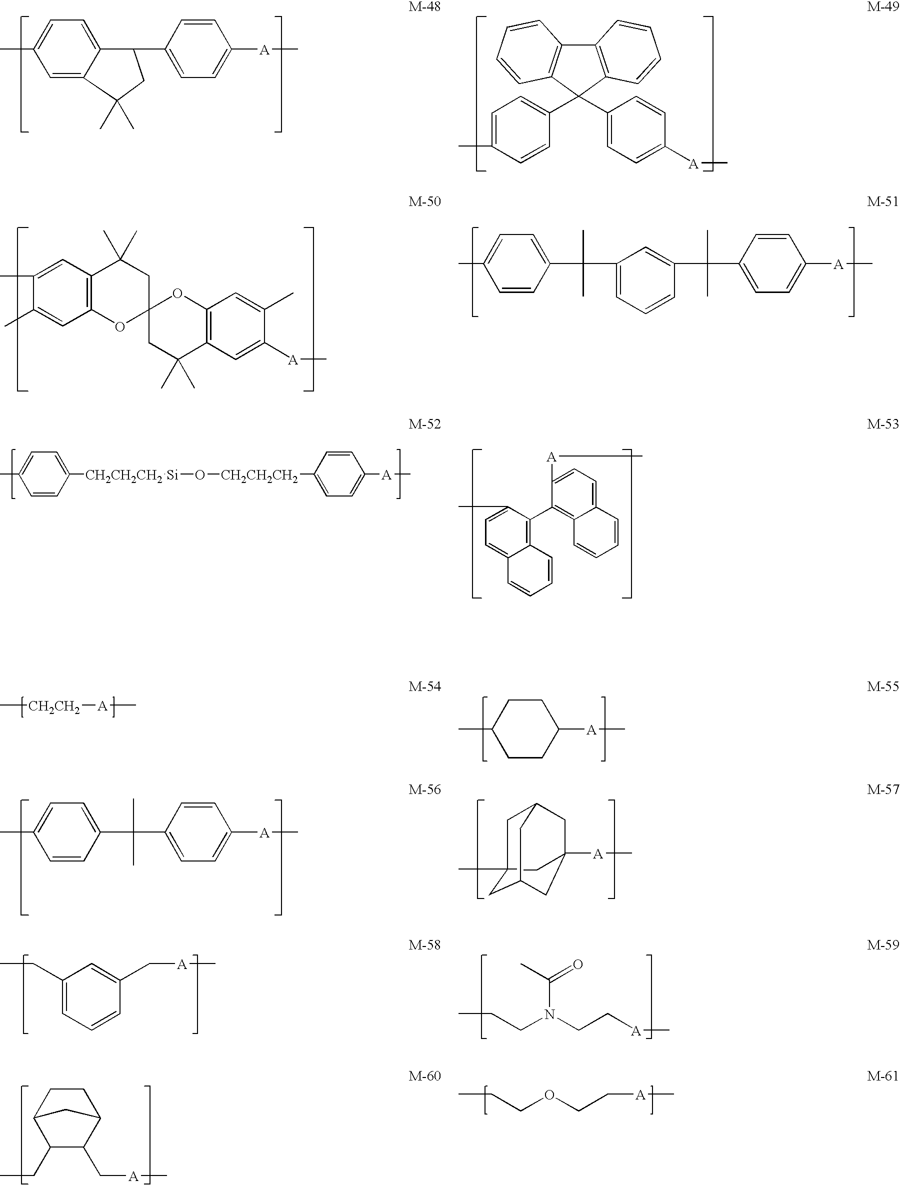

Examples of the repeating units of the polymer contained in the resin composition of the present invention include those consisting of a combination of the units represented by the formula (2) and (10), and further preferred examples of the units of the polymer contained in the resin composition will be mentioned below.

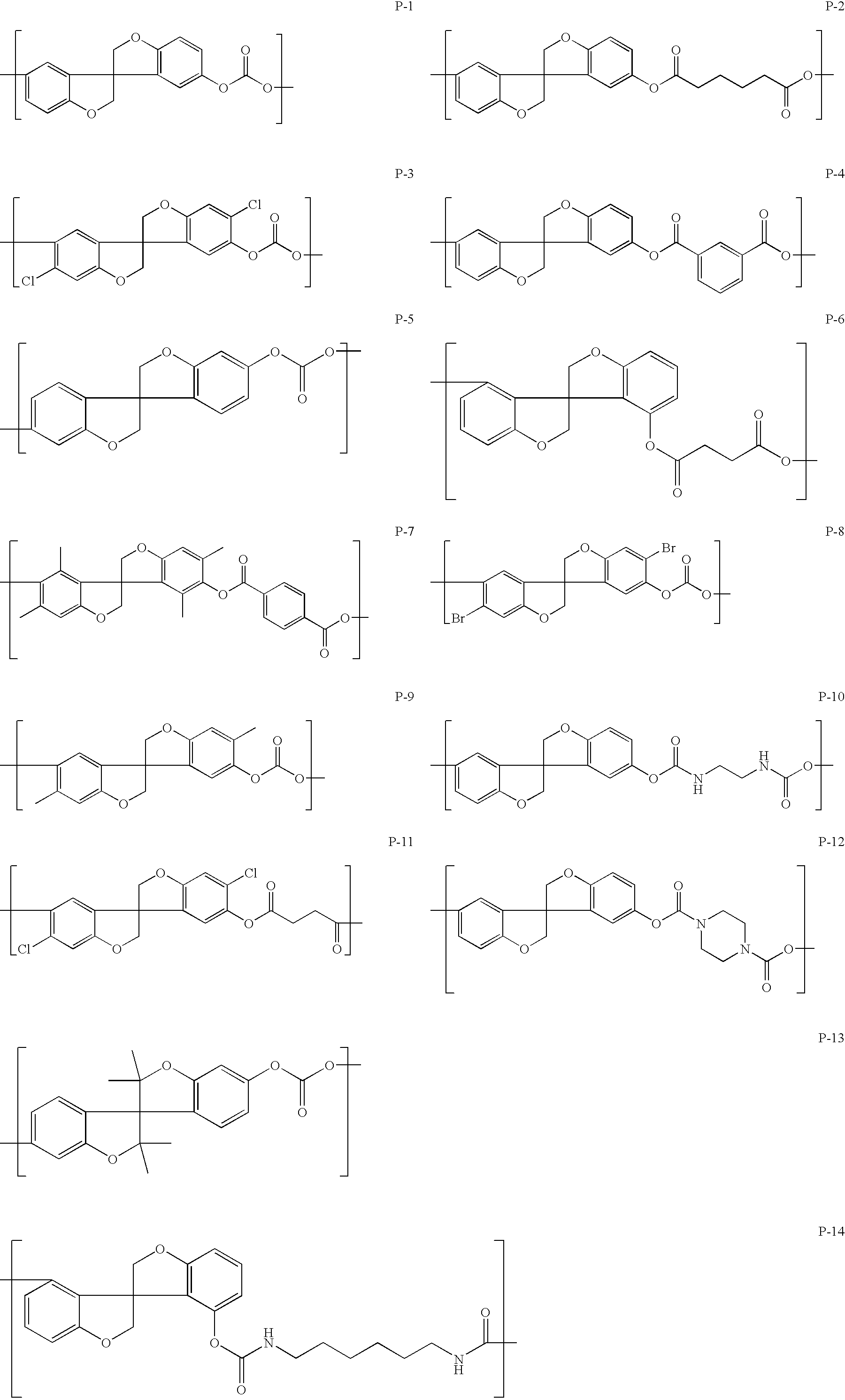

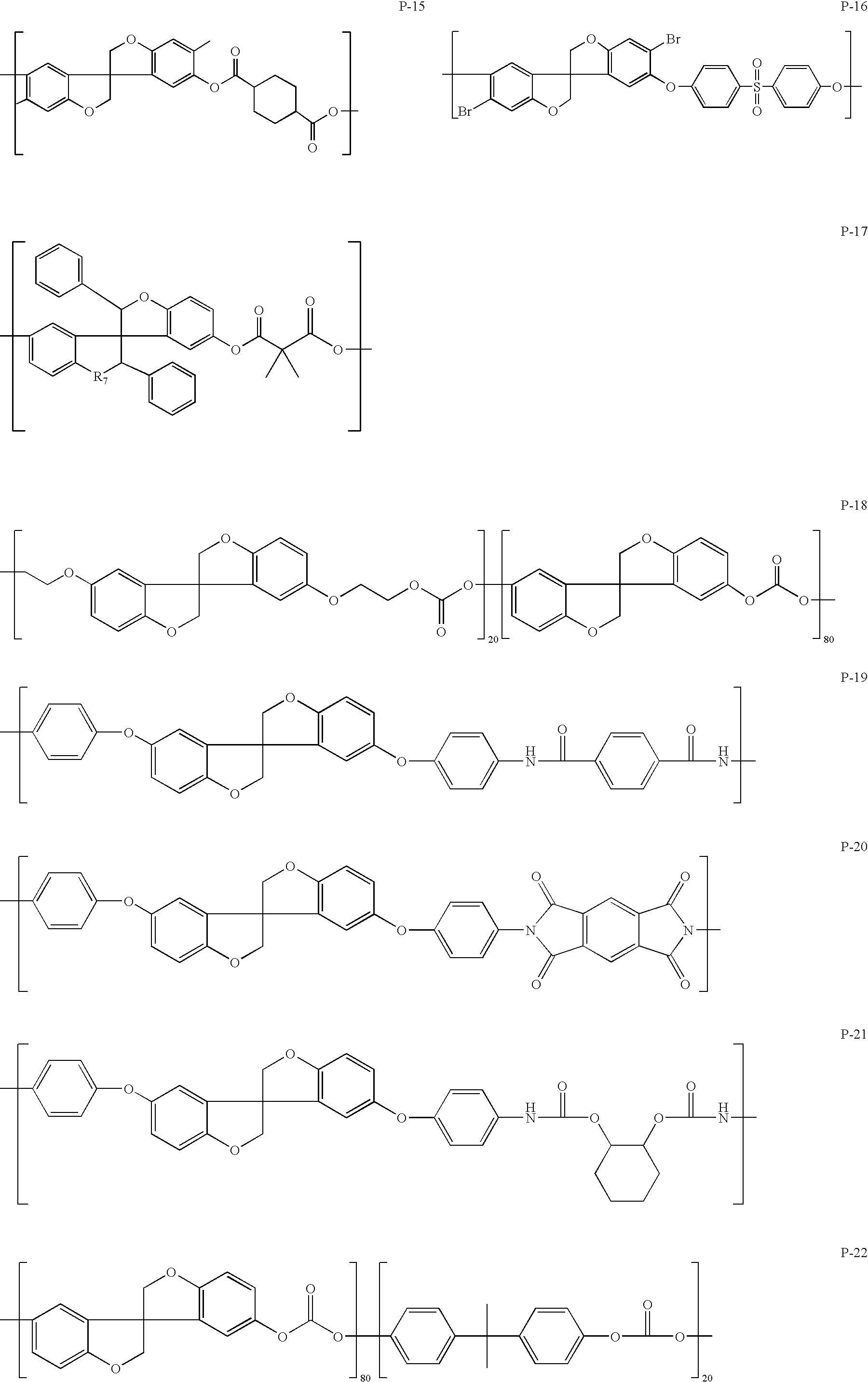

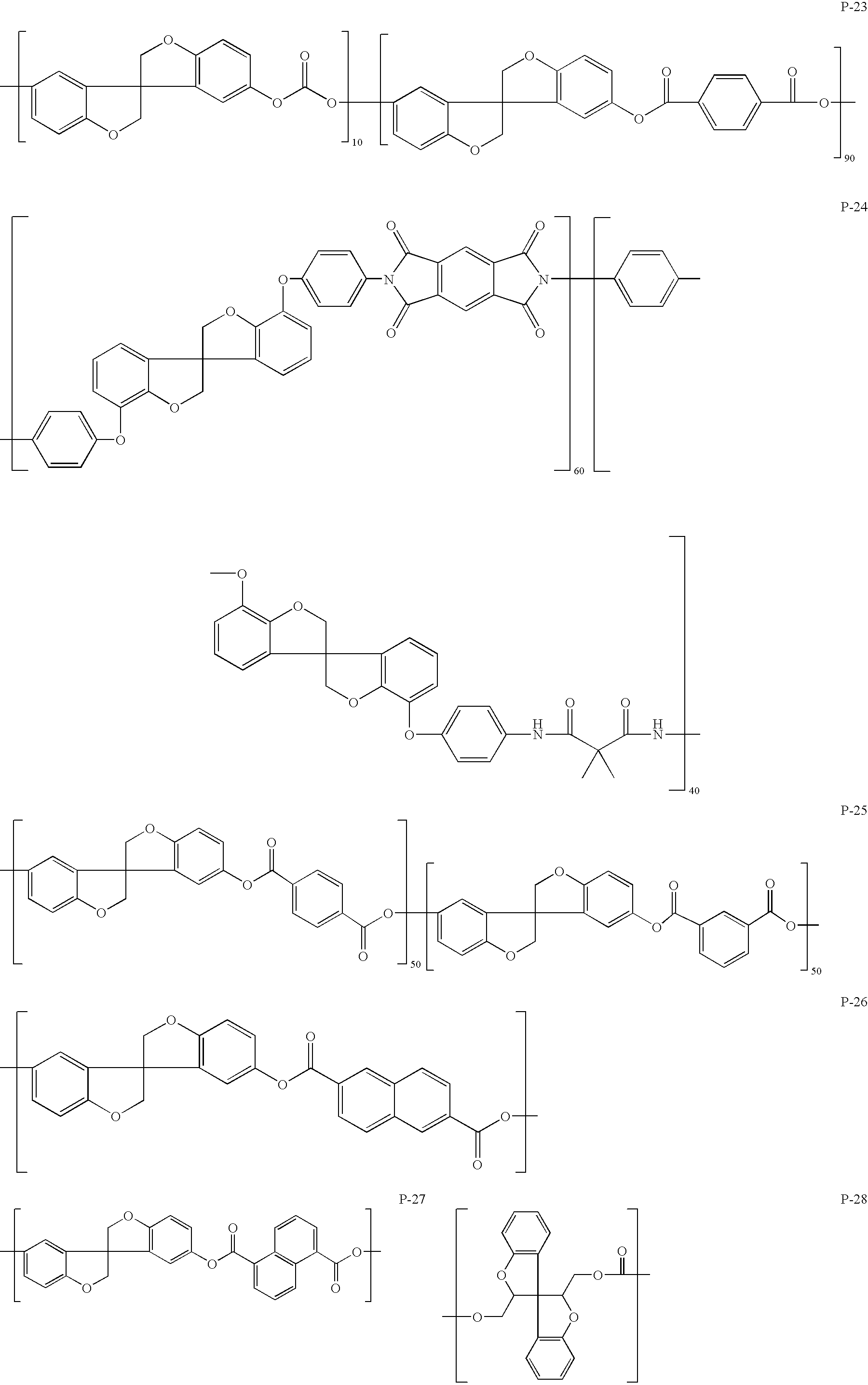

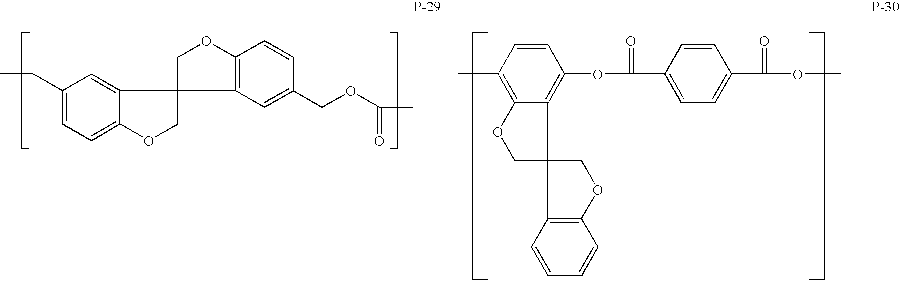

The resin composition of the present invention preferably has a glass transition temperature (Tg) of 100° C. or higher, more preferably 150 to 500° C., still more preferably 200 to 400° C. If the glass transition temperature is 200° C. or higher, superior heat resistance can be obtained when the composition is used for a film substrate.

The polymer contained in the resin composition of the present invention preferably has a molecular weight of 10,000 to 300,000, more preferably 20,000 to 200,000, most preferably 30,000 to 150,000, in terms of weight average molecular weight (converted to polystyrene). If the molecular weight is around 10,000 to 300,000, sufficient mechanical strength can be obtained for a film substrate utilizing the resin.

The resin composition of the present invention is a resin composition comprising a polymer containing a repeating unit represented by the aforementioned formula (2) or repeating units represented by the aforementioned formulas (2) and (10), and various polymers can be constituted depending on types of the divalent bridging groups L¹, L² and A. The polymer comprising a repeating unit represented by the aforementioned formula (2) or repeating units represented by the aforementioned formulas (2) and (10) is preferably at least one kind of polymer selected from the group consisting of polycarbonate, polyester, polyarylate, polyester carbonate, polysulfone, polyurethane, polyamide, polyimide and polyamidimide, particularly preferably at least one kind of polymer selected from polycarbonate, polyester, polyarylate and polyurethane.

The resin composition of the present invention can be blended with other resins so long as the advantages of the present invention are not degraded. The resin material to be blended with the resin composition of the present invention may be either a thermoplastic resin or a thermosetting resin.

Examples of the thermoplastic resin include methacrylic resins, methacrylic acid/maleic acid copolymers, polystyrenes, transparent fluororesins, polyimide resins, fluorinated polyimide resins, polyamide resins, polyamidimide resins, polyether imide resins, cellulose acylate resins, polyurethane resins, polyether ether ketone resins, polycarbonate resins, alicyclic polyolefin resins, polyarylate resins, polyether sulfone resins, polysulfone resins, cycloolefin copolymers, fluorene ring-modified polycarbonate resins, aliphatic ring-modified polycarbonate resins, acryloyl compounds and so forth. These thermoplastic resins preferably have a glass transition temperature (Tg) of 100° C. or higher.

Preferred examples of thermoplastic resins among those mentioned above include (Tg values are indicated in the parentheses) polycarbonate resins (PC, 140° C.), alicyclic polyolefin resins (e.g., ZEONOA 1600 produced by Nippon Zeon Co., Ltd., 160° C.; ARTON produced by JSR, 170° C.), polyarylate resins (PAr, 210° C.), polyether sulfone resins (PES, 220° C.), polysulfone resins (PSF, 190° C.), polyester resins (e.g., O-PET produced by Kanebo, Ltd., 125° C.; polyethylene terephthalates polyethylenenaphthalates), cycloolefin copolymers (COC, the compound described in Japanese Patent Laid-open Publication No. 2001-150584, Example 1, 162° C.), fluorene ring-modified polycarbonate resins (BCF-PC, the compound described in Japanese Patent Laid-open Publication No. 2000-227603, Example 4, 225° C.), aliphatic ring-modified polycarbonate resins (IP-PC, the compound described in Japanese Patent Laid-open No. 2000-227603, Example 5, 205° C.), and acryloyl compounds (the compound described in Japanese Patent Laid-open Publication No. 2002-80616, Example 1, 300° C. or higher).

Preferred examples further include polycarbonate resins containing a bisphenol represented by the following formula (13) as a bisphenol component.

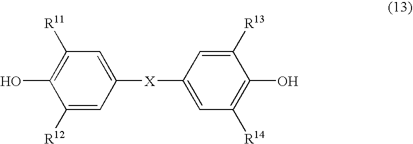

In the formula (13), R¹¹ to R¹⁴ are the same or different and represent at least one kind of group selected from hydrogen atom, a halogen atom, an alkyl group and an aryl group, preferably at least one kind of group selected from hydrogen atom, a halogen atom and an alkyl group. X represents a single bond or a divalent bridging group, and it is preferably at least one kind of group selected from a single bond, oxygen atom, sulfur atom, sulfonyl group, a cycloalkylene group having 5 to 10 carbon atoms, an aralkylene group having 7 to 15 carbon atoms and a haloalkylene group having 1 to 5 carbon atoms.

Specific examples of X in the formula (13) include, as cycloalkylene groups, 1,1-cyclopentylene group, 1,1-cyclohexylene group, 1,1-(3,3,5-trimethyl)cyclohexylene group, norbornane-2,2-diyl group and tricyclo[5.2.1.0^{2,6}]decane-8,8′-diyl group, and 1,1-cyclohexylene group and 1,1-(3,3,5-trimethyl)cyclohexylene group are particularly preferably used. Examples of the aralkylene group include phenylmethylene group, diphenylmethylene group, 1,1-(1-phenyl)ethylene group and 9,9-fluorenilene group. Further, examples of the haloalkylene group include 2,2-hexafluoropropylene group, 2,2-(1,1,3,3-tetrafluoro-1,3-dicyclo)propylene group and so forth.

The resin composition of the present invention preferably also contains a crosslinked resin in view of solvent resistance, heat resistance and so forth. As for type of the crosslinked resin, various known resins can be used without particular limitations for both of thermosetting resins and radiation-curable resins. Examples of the thermosetting resins include phenol resins, urea resins, melamine resins, unsaturated polyester resins, epoxy resins, silicone resins, diallyl phthalate resins, furan resins, bismaleimide resins, cyanate resins and so forth. As for the crosslinking method, any reactions that form a covalent bond may be used without any particular limitation, and systems in which the reaction proceed at room temperature, such as those utilizing a polyhydric alcohol compound and a polyisocyanate compound to form urethane bonds, can also be used without any particular limitation. However, such systems often have a problem concerning the pot life before the film formation, and therefore such systems are usually used as two-pack systems, in which, for example, a polyisocyanate compound is added immediately before the film formation.

On the other hand, when a one-pack system is used, it is effective to protect functional groups to be involved in the crosslinking reaction, and such systems are marketed as blocked type curing agents. Known as the marketed blocked type curing agents are B-882N produced by Mitsui Takeda Chemicals, Inc., Coronate 2513 produced by NIPPON POLYURETHANE INDUSTRY CO., LTD. (these are blocked polyisocyanates), Cymel 303 produced by Mitsui-Cytec Ltd. (methylated melamine resin) and so forth.

Moreover, blocked carboxylic acids, which are protected polycarboxylic acids usable as curing agents of epoxy resins, such as B-1 mentioned below are also known.

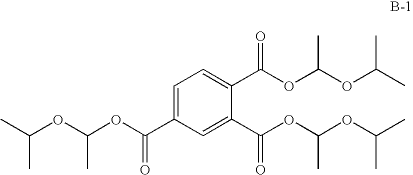

Examples of the radiation curable resins include radically curable resins and cationic curable resins. As a curable component of the radically curable resins, a compound having two or more radically polymerizable groups in the molecule is used, and as typical examples, compounds having 2 to 6 acrylic acid ester groups in the molecule called polyfunctional acrylate monomers, and compounds having two or more of acrylic acid ester groups in the molecule called urethane acrylates, polyester acrylates and epoxy acrylates are used. Typical examples of the method for curing radically curable resins include a method of irradiating an electron ray and a method of irradiating an ultraviolet ray. In the method of irradiating an ultraviolet ray, a polymerization initiator that generates a radical by ultraviolet irradiation is usually added. If a polymerization initiator that generates a radical by heating is added, the resins can also be used as thermosetting resins.

As a curable component of the cationic curable resins, a compound having two or more cationic polymerizable groups in the molecule is used. Typical examples of the curing method include a method of adding a photoacid generator that generates an acid by irradiation of an ultraviolet ray and irradiating an ultraviolet ray to attain curing. Examples of the cationic polymerizable compound include compounds containing a ring opening-polymerizable group such as epoxy group and compounds containing a vinyl ether group.

In the resin composition of the present invention, a mixture of two or more kinds of resins selected from each of the aforementioned thermosetting resins and radiation curable resins may be used, and a thermosetting resin and a radiation curable resin may also be used together. Further, a mixture of a crosslinkable resin and a resin not having a crosslinkable group may also be used.

The aforementioned crosslinkable resin is preferably admixed in the resin composition of the present invention, because solvent resistance, heat resistance, optical characteristics and toughness can be thereby obtained. Moreover, it is also possible to introduce crosslinkable groups into a polymer of the resin composition of the present invention, and such a polymer may have the crosslinkable group at any of end of polymer main chain, positions in polymer side chain and polymer main chain. When such a polymer is used, the resin composition of the present invention may not contain the aforementioned commonly used crosslinkable resin.

The resin composition of the present invention can contain a metal oxide/and or composite metal oxide as well as metal oxide obtained by a sol-gel reaction.

Preferred examples of the metal oxide that can be contained in the resin composition of the present invention include Al₂O₃, SiO₂, ZrO₂, Fe₂O₃, TiO₂, B₂O₃, WO₃ and so forth. Further, composite metal oxides that can be contained in the resin composition of the present invention have a structure in which different elements are bonded via oxygen (e.g., Al—O—Si) as a main constituent. In the present invention, such a composite oxide is represented as EₓO_{y}/FₘOₙ (In the formula, E represents one of metal among two kinds of metals contained in a binary composite oxide, and F represents the other metal. x, y, m and n are numbers providing preferred valences in the composite oxide.). For example, a composite oxide containing a bond represented as Al—O—Si as a main constituent is represented as Al₂O₃/SiO₂.

Examples of such composite oxides include binary composite oxides such as SiO₂/ZrO₂, SiO₂/Fe₂O₃, TiO₂/Fe₂O₃, Al₂O₃/SiO₂, Al₂O₃/TiO₂, Al₂O₃/ZrO₂ and Al₂O₃/Fe₂O₃, ternary composite oxides such as Al₂O₃/SiO₂/Fe₂O₃, Al₂O₃/SiO₂/TiO₂, Al₂O₃/TiO₂/ZrO₂ and Al₂O₃/SiO₂/ZrO₂, and polynary composite oxides containing more kinds of metals.

The metal oxides and composite metal oxides that can be contained in the resin composition of the present invention preferably have an average primary particle diameter of not less than 0.001 μm and not more than 0.1 μm, more preferably not less than 0.001 μm and not more than 0.03 μm.

The metal oxides and composite oxides that can be contained in the resin composition of the present invention may be modified with a surface treating agent for the surfaces thereof. Examples of surface treating agent used for the purposes of inhibiting aggregation as much as possible or improving affinity with resins include phosphoric acid and derivatives thereof (e.g., phosphoric acid esters, alkali metal salts of phosphoric acid, ammonium salts of phosphoric acid etc.), ammonium salts of polyacrylic acid, ammonium salts of polymethacrylic acid, alkali metal hydroxides, silane coupling agents, titanium coupling agents and so forth. The aforementioned surface treating agents are generally used in an amount of 5 weight % or less with respect to the weight of the metal oxide or composite metal oxide.

The metal oxides and composite metal oxides that can be used with the resin composition of the present invention can be obtained by a sol-gel reaction. Metal oxides provided by a sol-gel reaction are derived from a metal alkoxide or metal halide. Hereafter, explanations will be made by exemplifying preferred metal alkoxides.

In the present invention, any kinds of metal alkoxide compounds can used. Particularly preferred are compounds represented by the following formula (14).
G_{d}M (14)

In the formula (14), G represents an alkoxyl group having 1 to 8 carbon atoms, preferably 1 to 4 carbon atoms, M is a metal element selected from the group consisting of Si, Ti, Zr, Fe, Cu, Sn, B, Al, Ge, Ce, Ta, W and so forth, preferably a metal element selected from the group consisting of Si, Ti and Zr, and d represents an integer of 2 to 6.

Specific examples of the compounds of the formula (14) include tetraalkoxysilanes such as tetramethoxysilane, tetraethoxysilane, tetraisopropoxysilane and tetrabutoxysilane, tetraalkoxytitaniums such as tetra-n-propoxytitanium, tetraisopropoxytitanium and tetrabutoxytitanium, tetraalkoxyzirconiums such as tetra-n-propoxyzirconium, tetraisopropoxyzirconium and tetrabutoxyzirconium, metal alkoxides such as dimethoxycopper, diethoxybarium, trimethoxyboron, triethoxygallium, tributoxyaluminum, tetraethoxygermanium, tetrabutoxylead, penta-n-propoxytantalum and hexaethoxytungsten.

More preferred examples of metal oxides usable in the present invention and obtained by a sol-gel reaction include those derived from metal alkoxides and metal halides represented by the formula (15).

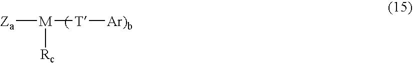

In the formula (15), Z represent an alkoxyl group or a halogen atom, M represents a metal atom, T′ represents a single bond or a divalent bridging group, R represents an organic group, and Ar represents an aromatic group. a and b represent an integer of 1 or larger, and c represents an integer of 0 or larger. a+b+c corresponds to the valence of the metal atom M. When Z represents an alkoxyl group, Z is preferably an alkoxyl group represented as R²⁰O—, where R²⁰ is a linear or branched organic group. This organic group may contain an unsaturated bond, ester bond, ether bond, thioether bond and peptide bond, as well as carboxyl group, amino group, ketone group and so forth, so long as the organic group has an alkyl group, aralkyl group or the like as a backbone, and the sol-gel reaction system is not affected. The organic group may contain 1 to 10 carbon atoms, preferably 1 to 5 carbon atoms. Z is preferably a halogen atom, and chlorine and bromine are particularly preferred.

Preferred examples of M include silicon, aluminum, titanium, zirconium, germanium and tin. As for combination of a, b and c, when M is a tetravalent metal, the combinations listed in Table 1 mentioned below are preferred.

TABLE 1

| | Exemplary | | |
|---|---|---|---|
| | combination | | |
| | a | b | c |
| (1) | 3 | 1 | 0 |
| (2) | 2 | 2 | 0 |
| (3) | 2 | 1 | 1 |
| (4) | 1 | 3 | 0 |
| (5) | 1 | 2 | 1 |
| (6) | 1 | 1 | 2 |

Further, when M is a trivalent metal, the combinations listed in Table 2 mentioned below are preferred.

TABLE 2

| | Exemplary | | |
|---|---|---|---|
| | combination | | |
| | a | b | c |
| (7) | 2 | 1 | 0 |
| (8) | 1 | 2 | 0 |
| (9) | 1 | 1 | 1 |

Specific examples of metal alkoxides having a tetravalent metal atom include (CH₃O)₃MPh, (C₂H₅O)₃M(CH₂Ph), (C₂H₃O)₃M(C₂H₄OPh), (C₃H₈NO)₃MPh, (C₄H₉O)₃M(C₃H₄Ph), (CH₄NO)₂MPh₂, (C₂H₅O)₂M(CH₃NPh)₂, (C₃H₅O)₂M(C₄H₈Ph)₂, (C₄H₁₀NO)₂M(C₂H₂O₂Ph)₂, (CH₃O)₂M(C₄H₉NPh)(C₄H₉), (C₂H₅O)₂M(C₄H₆O₂Ph)(C₃H₅), (C₂H₃O)₂M(C₂H₄Ph)(C₂H₅O), (C₃H₈NO)₂M(CH₂Ph)(CH₄N), (C₄H₉O)₂MPh(CH₃), (CH₄NO)₂MPh(C₂H₅), (C₂H₅O)₂M(CH₂Ph)(C₃H₇O), (C₃H₅O)₂M(C₂H₂Ph)(C₅H₉O₂), (C₄H₁₀NO)₂MPh(C₄H₁₀N), (CH₃O)₂M(CH₂OPh)(C₃H₇), (C₂H₅O)₂M(C₅H₈O₂Ph)(C₄H₉), (C₂H₃O)₂MPh(C₃H₈N), (C₃H₈NO)₂M(C₂H₄Ph)(C₂H₅), (C₄H₉O)₂MPh(C₂H₃O₂), (CH₄NO)₂MPh(C₃H₇), (C₂H₅O)₂M(CH₃NPh)(C₃H₅O₂), (C₃H₅O)₂M(C₄H₈Ph)(C₂H₃) and (C₄H₁₀NO)₂M(C₂H₂O₂Ph)(CH₃). Preferred are (CH₃O)₃MPh, (C₂H₅O)₃MPh, (C₃H₇O)₃MPh, (C₄H₉O)₃MPh, (CH₃O)₂MPh₂, (C₂H₅O)₂MPh₂, (C₃H₇O)₂MPh₂ and (C₄H₉O)₂MPh₂.

In the above formulas, M is silicon, titanium, zirconium, germanium or tin.

Specific examples of metal alkoxides having a trivalent metal atom (aluminum alkoxides) include (CH₃O)₂AlPh, (C₂H₅O)₂Al(CH₂Ph), (C₂H₃O)₂Al(C₂H₄OPh), (C₃H₈NO)₂AlPh, (C₄H₉O)₂Al(C₃H₄Ph), (CH₄NO)AlPh₂, (C₂H₅O)Al(CH₃NPh)₂, (C₃H₅O)Al(C₄H₈Ph)₂, (C₄H₁₀NO)Al(C₂H₂O₂Ph)₂, (CH₃O)Al(C₄H₉NPh)(C₄H₉), (C₂H₅O)Al(C₄H₆O₂Ph)(C₃H₅), (C₂H₃O)Al(C₂H₄Ph)(C₂H₅O), (C₃H₈NO)Al(CH₂Ph)(CH₄N), (C₄H₉O)AlPh(CH₃), (CH₄NO)AlPh(C₂H₅), (C₂H₅O)Al(CH₂Ph)(C₃H₇O), (C₃H₅O)Al(C₂H₂Ph)(C₅H₉O₂), (C₄H₁₀ONO)AlPh(C₄H₁₀N), (CH₃O)Al(CH₂OPh)(C₃H₇), (C₂H₅O)Al(C₅H₈O₂Ph)(C₄H₉), (C₂H₃O)AlPh(C₃H₈N), (C₃H₈NO)Al(C₂H₄Ph)(C₂H₅), (C₄H₉O)AlPh(C₂H₃O₂), (CH₄NO)AlPh(C₃H₇), (C₂H₅O)Al(CH₃NPh)(C₃H₅O₂), (C₃H₅O)Al(C₄H₈Ph)(C₂H₃) and (C₄H₁₀NO)Al(C₂H₂O₂Ph)(CH₃). Preferred are (CH₃O)₂AlPh, (C₂H₅O)₂AlPh, (C₃H₇O)₂AlPh, (C₄H₉O)₂AlPh, (CH₃O)AlPh₂, (C₂H₅O)AlPh₂, (C₃H₇O)AlPh₂ and (C₄H₉O)AlPh₂.

Specific examples of metal halides include F₂MPh₂, F₂M(CH₂Ph)₂, F₃MPh, F₃M(C₂H₄OPh), Cl₂MPh₂, Cl₃M(CH₂Ph), Cl₃MPh, Cl₃M(C₂H₄OPh), Br₂MPh₂, Br₂M(CH₂Ph)₂, Br₃MPh, Br₃M(C₂H₄OPh), I₂MPh₂, I₂M(CH₂Ph)₂, I₃MPh, I₃M(C₂H₄OPh), F₂AlPh, F₂Al(CH₂Ph), F₂Al(C₂H₄OPh), Cl₂AlPh, Cl₂Al(CH₂Ph), Cl₂Al(C₂H₄OPh), Br₂AlPh, Br₂Al(CH₂Ph), Br₂Al(C₂H₄OPh), I₂AlPh, I₂Al(CH₂Ph) and I₂Al(C₂H₄OPh). Preferred are F₂MPh₂, Cl₂MPh₂, Br₂MPh₂, I₂MPh₂, F₃MPh, Cl₃MPh, Br₃MPh and I₃MPh. In the above formulas, M is Si, Ti, Zr, Ge or Sn.

Among the metal alkoxides mentioned above, particularly preferred are PhSi(OMe)₃, PhSi(OEt)₃, (C₂H₅O)₃Si(CH₂Ph) and Ph₂GeCl₂.

Further, partial hydrolysates of the metal alkoxides and metal halides mentioned above and early phase condensates thereof such as dimers and trimers can also be used for the present invention. These metal alkoxides and metal halides may be used as each kind alone, or two or more kinds of them may be used together.

Although the content of the metal alkoxides and metal halides that can be contained in the resin composition of the present invention is not limited so long as the purpose of the present invention can be achieved, it is usually 5 to 70 weight %, preferably 10 to 60 weight %, more preferably 15 to 50 weight %.

Other than these metal oxides provided by a sol-gel reaction, various compounds mentioned below can be added to the resin composition of the present invention as required.
(a) Hydrolysis and condensation catalyst (sol-gel catalyst)
(b) Solvent
(c) Chelate ligand compound
(d) Water

Hereafter, various additives that can be used together will be explained in detail.

(a) Sol-Gel Catalyst

Various kinds of catalyst compounds can be used in sol solutions usable for the present invention for the purpose of promoting hydrolysis and partial condensation reactions of metal oxide precursors. The catalyst to be used is not particularly limited, and it can be used in an appropriate amount depending on the components of the sol solution used.

Generally effective catalysts are the compounds listed in (a1) to (a5) mentioned below, and a compound selected from them can be added in a required amount. Further, two or more kinds of compounds in these groups can be appropriately selected and used together, so long as the promotion effect of each compound is not inhibited.

(a1) Organic or Inorganic Acid

Examples of inorganic acid include hydrochloric acid, hydrogen bromide, hydrogen iodide, sulfuric acid, sulfurous acid, nitric acid, nitrous acid, phosphoric acid, phosphorous acid and so forth. Examples of organic compound include carboxylic acids (formic acid, acetic acid, propionic acid, butyric acid, succinic acid, cyclohexanecarboxylic acid, octanoic acid, maleic acid, 2-chloropropionic acid, cyanoacetic acid, trifluoroacetic acid, perfluorooctanoic acid, benzoic acid, pentafluorobenzoic acid, phthalic acid etc.), sulfonic acids (methanesulfonic acid, ethanesulfonic acid, trifluoromethanesulfonic acid, p-toluenesulfonic acid, pentafluorobenzenesulfonic acid etc.), phosphoric acids and phosphonic acids (phosphoric acid dimethyl ester, phenylphosphonic acid etc.), Lewis acids (boron trifluoride etherate, scandium triflate, alkyltitanic acid, aluminic acid etc.), heteropolyacids (phosphomolybdic acid, phosphotungstic acid etc.) and so forth.

(a2) Organic Base Compound or Inorganic Base Compound

Examples of inorganic base compound include sodium hydroxide, potassium hydroxide, calcium hydroxide, magnesium hydroxide, aluminum hydroxide, ammonia and so forth. Examples of organic base compound include amines (ethylenediamine, diethylenetriamine, triethylenetetramine, tetraethylenepentamine, triethylamine, dibutylamine, tetramethylethylenediamine, piperidine, piperazine, morpholine, ethanolamine, diazabicycloundecene, quinuclidine, aniline, pyridine etc.), phosphines (triphenylphosphine, trimethylphosphine etc.), and metal alkoxides (sodium methylate, potassium ethylate etc.).

(a3) Metal Chelate Compound

Metal chelate compounds having an alcohol represented by the formula R³⁰OH (wherein R³⁰ represents an alkyl group having 1 to 6 carbon atoms) and a diketone represented as R³¹COCH₂COR³² (wherein R³¹ represents an alkyl group having 1 to 6 carbon atoms, and R³² represents an alkyl group having 1 to 5 carbon atoms or an alkoxy group having 1 to 16 carbon atoms) as ligands as well as a metal as a center metal can be suitably used without any particular limitation. Two or more kinds of metal chelate compounds may be used in combination so long as they are in this category.

Those having Al, Ti or Zr as the center metal are particularly preferred as the metal chelate compounds usable for the present invention. Those selected from a group of compounds represented by the formulas Zr(OR³⁰)ₚ₁(R³¹COCHCOR³²)ₚ₂, Ti(OR³⁰)_{q1}(R³¹COCHCOR³²)q₂ and Al(OR³⁰)ᵣ₁(R³¹COCHCOR³²)ᵣ₂are preferred, and they have an action of promoting the condensation reaction of the aforementioned component (a).

R³⁰ and R³¹ in the metal chelate compounds may be the same or different, and examples include, for example, an alkyl group having 1 to 6 carbon atoms, specifically, ethyl group, n-propyl group, isopropyl group, n-butyl group, sec-butyl group, tert-butyl group, n-pentyl group, phenyl group and so forth. In addition to the aforementioned alkyl groups having 1 to 6 carbon atoms, R³² also represents an alkoxy group having 1 to 16 carbon atoms, for example, methoxy group, ethoxy group, n-propoxy group, isopropoxy group, n-butoxy group, sec-butoxy group, tert-butoxy group, lauryl group, stearyl group and so forth. In the metal chelate compounds, p1, p2, q1, q2, r1 and r2 are integers determined so as to obtain quadridentate or hexadentate ligands.

Specific examples of the metal chelate compounds include zirconium chelate compounds such as tri-n-butoxy(ethyl acetoacetate) zirconium, di-n-butoxy•bis(ethyl acetoacetate) zirconium, n-butoxy•tris(ethyl acetoacetate) zirconium, tetrakis(n-propyl acetoacetate) zirconium, tetrakis(acetyl acetoacetate) zirconium and tetrakis(ethyl acetoacetate) zirconium; titanium chelate compounds such as diisopropoxy•bis(ethyl acetoacetate) titanium, diisopropoxy•bis(acetyl acetate) titanium and diisopropoxy•bis(acetylacetone) titanium; aluminum chelate compounds such as diisopropoxy(ethyl acetoacetate) aluminum, diisopropoxy(acetyl acetonate) aluminum, isopropoxy•bis(ethyl acetoacetate) aluminum, isopropoxy•bis(acetyl acetonate) aluminum, tris(ethyl acetoacetate) aluminum, tris(acetyl acetonate) aluminum and monoacetyl acetonate•bis(ethyl acetoacetate) aluminum and so forth. Among these metal chelate compounds, tri-n-butoxy(ethyl acetoacetate) zirconium, diisopropoxy•bis(acetyl acetonate) titanium, diisopropoxy(ethyl acetoacetate) aluminum and tris(ethyl acetoacetate) aluminum are preferred. These metal chelate compounds can be used as each kind alone, or two or more kinds of them can be mixed and used in combination. Further, partial hydrolysates of these metal chelate compounds can also be used.

(a4) Organic Metal Compounds

Although preferred organic metal compounds are not particularly limited, organic transition metal compounds are preferred because of their high activity. Among these, tin compounds are particularly preferred because of their favorable stability and activity.

(a5) Metal Salts

As the metal salts, alkaline metal salts of organic acids (for example, sodium naphthenate, potassium naphthenate, sodium octanoate, sodium 2-ethylhexanoate, potassium laurate etc.) are preferably used.

The ratio of the sol-gel catalyst compound in the sol solution is usually 0.01 to 50 weight %, preferably 0.1 to 50 weight %, more preferably 0.5 to 10 weight %, with respect to a metal oxide precursor, which is a raw material of the sol solution.

(b) Solvent

As the organic solvent used for preparing the sol solution, a solvent that can dissolve the resin composition of the present invention, metal alkoxide and metal halide and contain water in such an amount that hydrolysis of the metal alkoxide and metal halide can be proceeded. The solvent allows all ingredients in the sol solution to be uniformly mixed, thereby adjusts solid matter in the sol solution of the present invention, enables use of various coating methods, and improve dispersion stability and storage stability of the sol solution. The solvent is not particularly limited so long as the aforementioned objects can be achieved.

Preferred examples of the solvent include, for example, water, alcohols, aromatic hydrocarbons, ethers, ketones, esters, amides, sulfoxides, halogenated type solvents and mixed solvents of these. Specific examples of preferred solvents include benzene, toluene, xylene, ethyl acetate, butyl acetate, methanol, ethanol, isopropanol, 2-butanol, acetone, methyl ethyl ketone, diethyl ketone, methyl isobutyl ketone, dimethylformamide, N-methylpyrrolidone, N,N-dimethylimidazolidinone, dimethyl sulfoxide, dimethyl ether, diethyl ether, tetrahydrofuran, methylene chloride and chloroform. When the composition is prepared as a solution, solid matter concentration is usually about 5 to 40 weight %, preferably 10 to 25 weight %.

These organic solvents can be used as each kind alone, or two or more kinds of them can be mixed for use. The ratio of the organic solvent in the sol solution is not particularly limited, and they are used in such an amount that the total solid matter concentration can be adjusted depending on the purpose of use.

(c) Chelate Ligand Compound

When a metal complex compound is used in the sol solution, it is also preferable to use a compound having an ability to coordinate a chelate in view of control of curing reaction rate or improvement of stability of the solution. Preferably used are β-diketones and/or β-ketoesters, and they act as stability improver for the sol solution.

Specific examples of the β-diketones and/or β-ketoesters include acetylacetone, methyl acetoacetate, ethyl acetoacetate, n-propyl acetoacetate, isopropyl acetoacetate, n-butyl acetoacetate, sec-butyl acetoacetate, tert-butyl acetoacetate, 2,4-hexanedione, 2,4-heptanedione, 3,5-heptanedione, 2,4-octanedione, 2,4-nonanedione, 5-methylhexanedione and so forth. Among these, ethyl acetoacetate and acetylacetone are preferred, and acetylacetone is particularly preferred. One kind of these β-diketones and/or β-ketoesters can solely be used, or two or more kinds of these can be used as a mixture. These β-diketones and/or β-ketoesters are used in an amount of 2 moles or more, preferably 3 to 20 moles, with respect to 1 mole of the metal chelate compound. If the amount is less than 2 moles, the obtained sol solution shows poor storage stability.

(d) Water

Water is added to the sol solution for hydrolysis and condensation reactions of the metal oxide precursor. The amount of water used is usually about 1.2 to 5.0 moles, preferably 1.3 to 4.0 moles, with respect to 1 mole of the metal oxide precursor. A sol solution preferably used for the present invention has a total solid matter content of 0.1 to 50 weight %, preferably 1 to 40 weight %, and if the total solid concentration exceeds 50 weight %, storage stability of the composition is unfavorably degraded.

The resin composition of the present invention may also contain an inorganic layered compound. By adding an inorganic layered compound to the resin composition of the present invention, the thermal deformation temperature thereof is improved by 2 to 100° C. If the resin composition added with an inorganic layered compound is used for a plastic film substrate, it can be used as a gas barrier film.

Although the inorganic layered compound used for the present invention is not particularly limited, clay minerals, hydrotalcite compounds and other similar compounds having swelling property and/or cleavage property are preferably used.

Examples of such clay minerals includes kaolinite, dickite, nacrite, halloysite, antigorite, chrysotile, pyrophyllite, montmorillonite, beidellite, nontronite, saponite, sauconite, stevensite, hectorite, tetrasilylic mica, sodium taeniolite, muscovite, margarite, talc, vermiculite, phlogopite, xanthophyllite, chlorite and so forth.

The aforementioned inorganic layered compounds may be either natural substances or synthesized substances. Further, these layered compounds may be used as each kind alone, or two or more kinds of them may be used together.

Shape of the aforementioned inorganic layered compounds is not particularly limited. However, thickness of the inorganic layered compound is preferably a thickness of one layer (about 1 nm) as far as possible. The average length thereof is 0.01 to 50 μm, preferably 0.05 to 10 μm, and a layered compound having an aspect ratio of 20 to 500, preferably 50 to 200, can be preferably used.

The aforementioned inorganic layered compound has ion-exchangeable inorganic cations between layers (also on surfaces of uppermost and lowermost layers of inorganic layered compounds). The ion-exchangeable inorganic cations mean metal ions such as those of sodium, potassium and lithium existing on crystal surfaces of the inorganic layered compound (e.g., layered silicate). These ions exhibit an ion exchangeable property with a cationic substance, and thus various substances having a cationic property can be intercalated between the layers of the aforementioned inorganic layered compound by an ion exchange reaction.

For exchange of inorganic cations existing between layers of the aforementioned inorganic layered compound for organic cations, alkylammonium ions containing a long-chain alkyl group are preferably used as the organic cations. Examples of the alkylammonium ions containing a long-chain alkyl group include, for example, tetrabutylammonium ion, tetrahexylammonium ion, dihexyldimethylammonium ion, dioctyldimethylammonium ion, hexyltrimethylammonium ion, octyltrimethylammonium ion, dodecyltrimethylammonium ion, hexadecyltrimethylammonium ion, octadecyltrimethylammonium ion, dioctadecyldimethylammonium ion, docosenyltrimethylammonium ion, hexadecyltrimethylammonium ion, tetradecyldimethylbenzylammonium ion, octadecyldimethylbenzylammonium ion, dioleyldimethylammonium ion, polyoxyethylene dodecylmonomethylammonium ion and so forth.

Although the cation exchange capacity (CEC) of the aforementioned inorganic layered compound is not particularly limited, it is, for example, preferably 25 to 200 meq/100 g, more preferably 50 to 150 meq/100 g, further preferably 90 to 130 meq/100 g. If the cation exchange capacity of the inorganic layered compound is less than 25 meq/100 g, amount of cationic substance that can be inserted (intercalated) between layers of the layered compound by ion exchange becomes small, and the layers may not be sufficiently organophilized. On the other hand, if the cation exchange capacity exceeds 200 meq/100 g, bonding strength between layers of the inorganic layered compound becomes too strong. Thus, cleavage of crystal leaves becomes difficult, and dispersibility may be degraded.

Specific examples of the inorganic layered compound include, for example, marketed products such as Sumecton SA produced Kunimine Industries, Kunipia F produced by Kunimine Industries, Somasif ME-100 produced by CO-OP Chemical and Lucentite SWN produced by CO-OP Chemical.

As the method for exchanging inorganic cations existing between layers of the aforementioned inorganic layered compound for organic cations (organophilization), a wet method is generally used. That is, in the wet method, an inorganic layered compound is sufficiently solvated with water, alcohol or the like, then added with organic cations and stirred so that organic cations should substitute for metal ions existing between layers of the layered compound. Then, unsubstituted organic cations are sufficiently washed off, and the compound is taken by filtration and dried. In addition, it is also possible that the layered compound and organic cations are directly reacted in an organic solvent, or the inorganic layered compound and organic cations are reacted by heating and kneading them in the presence of a resin or the like in an extruder.

The mixing ratio of the aforementioned inorganic layered compound and the resin composition of the present invention is preferably 1/100 to 100/20, more preferably 5/100 to 100/50, in terms of weight ratio. If the content of the inorganic layered compound is less than 1 part by weight with respect to 100 parts by weight of the resin composition of the present invention, sufficient heat resistance and gas barrier property may not be obtained. On the other hand, if the content of the resin composition of the present invention is less than 20 parts by weight with respect to 100 parts by weight of the inorganic layered compound, brittleness etc. may be degraded.

When a layer of the resin composition of the present invention containing the inorganic layered compound is formed, the inorganic layered compound and the resin composition of the present invention are preferably fusion kneaded or mixed in a solution first to prepare a resin composition in which the inorganic layered compound in a cleaved state is dispersed in the resin. In view of the production process and cost, they are preferably mixed by the fusion kneading method.

As the fusion kneading apparatus usable for the aforementioned fusion kneading, kneading apparatuses generally used for thermoplastic resins can be used. For example, a single or multi-screw kneading extruder, roller, Banbury mixer and so forth may be used.

The resin composition of the present invention may be further added with various additives (resin property modifiers) such as plasticizers, dyes and pigments, antioxidants, antistatic agents, ultraviolet absorbers, inorganic microparticles, release accelerators, leveling agents and lubricants as required in such a degree that the advantages of the present invention are not degraded.

[Plastic Film Substrate and Transparent Conductive Film Substrate]

The plastic film substrate of the present invention can be prepared by using the resin composition of the present invention.

Known methods can be employed as a method for molding the resin composition of the present invention into a film substrate, and solution casting method and extrusion method (fusion molding method) can be mentioned as preferred methods. The casting and drying processes of the solution casting method are described in U.S. Pat. Nos. 2,336,310, 2,367,603, 2,492,078, 2,492,977, 2,492,978, 2,607,704, 2,739,069, 2,739,070, British Patent Nos. 640,731, 736,892, Japanese Patent Publication (Kokoku) Nos. 45-4554, 49-5614, Japanese Patent Laid-open Publication Nos. 60-176834, 60-203430 and 62-115035. A solution of the resin composition is preferably cast on a drum or band having a surface temperature of 30° C. or lower, particularly preferably on a metal support having a surface temperature of −10 to 20° C.

Examples of production apparatus for the production of the plastic film substrate of the present invention by the solution casting method include the production apparatuses described in Japanese Patent Laid-open No. 2002-189126, paragraphs [0061] to [0068], FIG. 1, FIG. 2 and so forth. However, the present invention is not limited to use of these apparatuses.

In the solution casting method, the resin composition of the present invention is dissolved in a solvent. Any solvent may be used as the solvent used, so long as a solvent that can dissolve the resin composition of the present invention is chosen. However, a solvent that can dissolve solid matter at a concentration of 10% or more at 25° C. is particularly preferred. Further, the solvent used preferably has a boiling point of 200° C. or lower, more preferably 150° C. or lower. When the boiling point is high, drying of the solvent may become insufficient, and thus it may remain in a film.

Examples of solvents satisfying the aforementioned requirements include methylene chloride, chloroform, tetrahydrofuran, benzene, cyclohexane, toluene, xylene, 1,2-dichloroethane, ethyl acetate, acetone, chlorobenzene, dimethylformamide, methanol, ethanol and so forth. However, the present invention is not limited to use of these solvents. Further, two or more kinds of solvents may be mixed for use.

Examples of mixed solvent include solvents obtained by mixing methylene chloride with one or several kinds of alcohols having 1 to 5 carbon atoms, and such solvents preferably has an alcohol content of 5 to 20 weight % with respect to the total solvent. Preferred examples further include solvents obtained by appropriately mixing ether, ketone and ester having 3 to 12 carbon atoms, and such solvents may contain one or several kinds of alcohols having 1 to 5 carbon atoms. Further, the solvents exemplified in Japanese Technical Disclosure No. 2001-1745 (Japan Institute of Invention and Innovation), paragraph 6 and so forth are also included in preferred examples.

A solution used for the solution casting preferably has a resin concentration of 5 to 60 weight %, preferably 10 to 40 weight %, more preferably 10 to 30 weight %. If the resin concentration is too low, viscosity becomes small, and thus it becomes difficult to control the thickness. On the other hand, if the resin concentration is too high, film formation property is degraded, and thus unevenness becomes significant.

Although the method for solution casting is not particularly limited, a solution can be cast on a flat plate or roller by using a bar coater, T-die, T-die with bar, doctor blade, roller coater, die coater and so forth.

Although the temperature for drying the solvent may vary depending on the boiling point of the solvent used, drying is preferably performed in two stages. For the first stage, drying is performed at 30 to 100° C. until the weight concentration of the solvent becomes 10% or less, more preferably 5% or less. Subsequently, the film is removed from a flat plate or roller, and drying is performed at a temperature not lower than 60° C. and not higher than the glass transition temperature of the resin as the second stage. As for removal of the film from the flat plate or roller, the film may be removed immediately after the drying of the first stage, or it may be cooled once and then removed.

Conditions for the extrusion molding are similar to the conditions used for commonly used optical resins. The melting temperature usually employed is in the range of 180 to 350° C., and a temperature of 200 to 300° C. is particularly preferably used.

The plastic film substrate of the present invention may be stretched. Stretching provides advantages of improvement of mechanical strengths of the film such as anti-folding strength, and thus improvement of handling property of the film. In particular, a film having an orientation release stress (ASTM D1504, henceforth abbreviated as “ORS”) of 0.3 to 3 GPa along the stretching direction is preferred, because mechanical strength of such a film is improved. ORS is internal stress present in a stretched film or sheet generated by stretching.

Known methods can be used for the stretching, and the stretching can be performed by, for example, the monoaxial stretching method by roller, monoaxial stretching method by tenter, simultaneous biaxial stretching method, sequential biaxial stretching method or inflation method at a temperature of from a temperature higher than the glass transition temperature (Tg) of the resin by 10° C. to a temperature higher than Tg by 50° C. The stretching ratio is preferably 1.1 to 3.5 times.

Although the thickness of the plastic film substrate of the present invention is not particularly limited, it is preferably 30 to 700 μm, more preferably 40 to 200 μm, still more preferably 50 to 150 μm. The haze of the plastic film substrate is preferably 3% or less, more preferably 2% or less, still more preferably 1% or less, regardless of the thickness. Further, the total light transmission of the plastic film is preferably 70% or more, more preferably 80% or more, still more preferably 90% or more.

The surface of the plastic film substrate of the present invention may be subjected to saponification, corona discharge treatment, flame treatment, glow discharge treatment or the like in order to improve adhesion with other layers or components. An anchor layer may also be provided on the film surface.

The plastic film substrate of the present invention can be made into a transparent conductive film substrate by providing a transparent conductive layer. As the transparent conductive layer, known metal films and metal oxide films can be used. Metal oxide films are particularly preferred in view of transparency, conductivity and mechanical characteristics. Examples include, for example, metal oxide films such as those of indium oxide, cadmium oxide and tin oxide added with tin, tellurium, cadmium, molybdenum, tungsten, fluorine, zinc, germanium or the like as impurities, zinc oxide, titanium oxide and so forth added with aluminum as impurities. In particular, thin films of indium oxide consisting mainly of tin oxide and containing 2 to 15 weight % of zinc oxide have superior transparency and conductivity, and therefore they are preferably used.

Although the film formation method for the transparent conductive layer may be any method so long as a desired thin film can be formed, a vapor phase deposition method in which a material is deposited from a vapor phase to form a film, such as the sputtering method, vacuum deposition method, ion plating method and plasma CVD method is preferred. The film formation can be attained by, for example, the methods described in Japanese Patent No. 3400324, Japanese Patent Laid-open Publication Nos. 2002-322561 and 2002-361774. The sputtering method is particularly preferred above all, because it can provide superior conductivity and transparency.

Preferred degree of vacuum used for the sputtering method, vacuum deposition method, ion plating method, plasma CVD method is 0.133 mPa to 6.65 Pa, more preferably 0.665 mPa to 1.33 Pa. Before such a transparent conductive layer is provided, the plastic film substrate is preferably subjected to a surface treatment such as plasma treatment (reverse sputtering) and corona discharge treatment. Further, during the preparation of the transparent conductive layer, the temperature may be raised to 50 to 200° C.

The transparent conductive layer formed as described above preferably has a film thickness of 20 to 500 nm, more preferably 50 to 300 nm. Further, the transparent conductive layer formed as described above has a surface electric resistance of 0.1 to 200 Ω/□, more preferably 0.1 to 100 Ω/□, still more preferably 0.5 to 60 Ω/□, as measured at 25° C. and 60% RH (relative humidity). Furthermore, the transparent conductive layer preferably has a light transmission of 80% or more, more preferably 83% or more, further preferably 85% or more.

The plastic film substrate of the present invention is also preferably provided with a gas barrier layer in order to suppress gas permeability. Examples of preferred gas barrier layer include, for example, those of metal oxides containing one or more kinds of metals selected from the group consisting of silicon, aluminum, magnesium, zinc, zirconium, titanium, yttrium and tantalum as a main component, metal nitrides of silicon, aluminum and boron, and mixtures thereof. Among these, metal oxides containing silicon oxide containing oxygen atoms at an atomic number ratio of 1.5 to 2.0 with respect to silicon atoms as a main component are preferred in view of gas barrier property, transparency, surface smoothness, flexibility, membrane stress, cost and so forth. Such an inorganic gas barrier layer can be prepared by, for example, a vapor phase deposition method in which a material is deposited from a vapor phase to form a film, such as the sputtering method, vacuum deposition method, ion plating method and plasma CVD method. Among these, the sputtering method is preferred, because it can provide particularly superior gas barrier property. Further, during the preparation of the transparent conductive layer, the temperature may be raised to 50 to 200° C.

The inorganic gas barrier layer obtained as described above preferably has a film thickness of 10 to 300 nm, more preferably 30 to 200 nm. Although the gas barrier layer may be provided on the same side as the transparent conductive layer, or the side opposite to the transparent conductive layer side, it is preferably provided on the side opposite to the transparent conductive layer side.

The plastic film substrate provided with a gas barrier layer preferably has a water vapor permeability of 0.01 to 5 g/m²•day, more preferably 0.03 to 3 g/m²•day, still more preferably 0.05 to 2 g/m²•day, as measured at 40° C. and 90% RH, and an oxygen permeability of 0.01 to 1 mL/m²•day, more preferably 0.01 to 0.7 mL/m²•day, still more preferably 0.01 to 0.5 mL/m²•day, as measured at 40° C. and 90% RH.

In order to improve the barrier property, a defect compensating layer is particularly desirably provided adjacent to the gas barrier layer. The defect compensating layer can be prepared by (1) a method of utilizing an inorganic oxide layer prepared by using a sol-gel method as disclosed in U.S. Pat. No. 6,171,663 and Japanese Patent Laid-open No. 2003-94572, (2) a method of utilizing an organic substance layer as disclosed in U.S. Pat. No. 6,413,645, or a method of depositing a layer by vacuum vapor deposition and curing it with an ultraviolet ray or electron beam, or by coating a layer and then curing it with heating, electron beam, ultraviolet ray or the like. When the layer is prepared by using coating, various conventionally used coating methods such as spray coating, spin coating and bar coating can be used.

[Optical Component and Image Display Device (Flat Panel Display)]

The resin composition of the present invention and a plastic film substrate utilizing it can be used for optical components and image display devices. The image display devices referred to herein are not particularly limited, and they may be conventionally known image display devices. Further, flat panel displays showing superior display quality can be produced by using the plastic film substrate of the present invention. Examples of display devices of flat panel displays include liquid crystal panels, plasma displays, electroluminescence (EL) panels, fluorescent character display tubes, light emitting diodes and so forth, and other than these, the plastic film substrate can be used as a substrate replacing glass substrates of display devices in which glass substrates have conventionally been used. Furthermore, in addition to displays, the present invention can also be used for applications of optical components such as solar battery and touch panel. As for touch panel, the present invention can be applied to those disclosed in Japanese Patent Laid-open Publication Nos. 5-127822, 2002-48913 and so forth.

When the plastic film substrate of the present invention is used for liquid crystal displays and so forth, the resin composition of the present invention is preferably an amorphous polymer so that optical uniformity can be attained. Furthermore, for the purpose of controlling retardation (Re) and wavelength dispersion thereof, resins having positive and negative intrinsic birefringences may be combined, or a resin showing larger (or smaller) wavelength dispersion may be combined.

In the plastic film substrate of the present invention, a laminate of different resins may be preferably used in order to control retardation (Re) or improve gas permeability and mechanical characteristics. No particular limitation is imposed on preferred combinations of different resins, and any combinations of the aforementioned resins can be used.

A reflection type liquid crystal display device has, in the order from the bottom, a lower substrate, reflective electrode, lower oriented film, liquid crystal layer, upper oriented film, transparent electrode, upper substrate, λ/4 plate and polarizing film. The plastic film substrate of the present invention can be used as the aforementioned transparent electrode and upper substrate. In the case of a color display device, it is preferable to further provide a color filter layer between the reflective electrode and the lower oriented film or between the upper oriented film and the transparent electrode.

A transmission type liquid crystal display device has, in the order from the bottom, a back light, polarizing plate, λ/4 plate, lower transparent electrode, lower oriented film, liquid crystal layer, upper oriented film, upper transparent electrode, upper substrate, λ/4 plate, and polarization film. Among these, the plastic film substrate of the present invention can be used as the aforementioned upper transparent electrode and upper substrate. In the case of a color display device, it is preferable to further provide a color filter layer between the lower transparent electrode and the lower oriented film or between the upper oriented film and the transparent electrode.

Type of liquid crystal cell is not particularly limited, and various display modes such as TN (Twisted Nematic), IPS (In-Plane Switching), FLC (Ferroelectric Liquid Crystal), AFLC (Anti-ferroelectric Liquid Crystal), OCB (Optically Compensatory Bend), STN (Supper Twisted Nematic), VA (Vertically Aligned) and HAN (Hybrid Aligned Nematic) have been proposed. Furthermore, display modes in which alignment division (multi-domain) is adopted with the aforementioned display modes have also been proposed. A film for protecting a polarizing plate and polarizing plate utilizing the plastic film substrate of the present invention are effective in liquid crystal display of any display mode. Furthermore, they are also effective in any of liquid crystal displays of transmission type, reflection type and semi-transmission type.

These display modes are disclosed in Japanese Patent Laid-open Publication No. 2-176625, Japanese Patent Publication No. 7-69536, MVA in SID97, Digest of tech. Papers, 28 (1997) 845, SID99, Digest of tech. Papers 30, (1999) 206, Japanese Patent Laid-open Publication No. 11-258605, SURVAIVAL in Monthly Display, Vol. 6, No. 3 (1999) 14, PVA in Asia Display 98, Proc. of the-18th-Inter. Display res. Conf. (1998) 383, Para-A in LCD/PDP Iternational '99, DDVA in SID98, Digest of tech. Papers 29 (1998) 838, EOC in SID98, Digest of tech. Papers, 29 (1998) 319, PSHA in SID98, Digest of tech. Papers, 29 (1998) 1081, RFFMH in Asia Display 98, Proc. of the-18th-Inter. Display res. Conf. (1998) 375, HMD in SID98, Digest of tech. Papers, 29 (1998) 702, Japanese Patent Laid-open Publication No. 10-123478, International Patent Publication WO98/48320, Japanese Patent No. 3022477, International Patent Publication WO00/65384 and so forth.

The plastic film substrate of the present invention can be used for use in an organic EL display. Specific examples of layer structure of organic EL display device include positive electrode/luminescent layer/transparent negative electrode, positive electrode/luminescent layer/electron transport layer/transparent negative electrode, positive electrode/hole transport layer/luminescent layer/electron transport layer/transparent negative electrode, positive electrode/hole transport layer/luminescent layer/transparent negative electrode, positive electrode/luminescent layer/electron transport layer/electron injection layer/transparent negative electrode, positive electrode/hole injection layer/hole transport layer/luminescent layer/electron transport layer/electron injection layer/transparent negative electrode and so forth.

With an organic EL device for which the plastic film substrate of the present invention can be used, light emission can be obtained by applying a direct current (alternating current component may be included as required) voltage (usually 2 to 40 V) or direct current between the positive electrode and the negative electrode. For driving of such light emitting elements, the methods described in Japanese Patent Laid-open Publication Nos. 2-148687, 6-301355, 5-29080, 7-134558, 8-234685, 8-241047, U.S. Pat. Nos. 5,828,429, 6,023,308, Japanese Patent No. 2784615 and so forth can be used.

### EXAMPLES

Hereafter, the present invention will be further specifically explained by referring to examples. However, the present invention is not limited to these.

Methods for measuring characteristic values of resin compositions, plastic film substrates and transparent conductive film substrates of the present invention are shown below.

(1) Weight Average Molecular Weight of Resin Composition

Weight average molecular weights were obtained by GPC measurement providing polystyrene-converted molecular weights using HLC-8120 GPC produced by Tosoh Corp. and tetrahydrofuran as solvent and comparison with molecular weight standards of polystyrene.

(2) Glass Transition Temperature (Tg) of Resin Composition

Glass transition temperatures were measured by DSC method (in nitrogen gas, temperature increasing rate: 10° C./minute) using DSC 6200 produced by SEIKO Co., Ltd.

(3) Thickness of Film Substrate

Thickness was measured by using a dial type thickness gauge, K402B, produced by ANRITSU Corp.

(4) Retardation (Re) of Film Substrate

Refractive index values were measured at a wavelength of 632.8 nm for directions along film plane by using an automatic birefringence meter (KOBRA-21ADH produced by Oji Scientific Instruments Co., Ltd.), and retardation was calculated from the values in accordance with the following equation.
Retardation (Re)=|nMD−nTD|×d

In the equation, nMD is a refractive index of a film for transverse direction, nTD is a refractive index of the film for longitudinal direction, and d is thickness of the film.

(5) Light Transmission of Film Substrate

Transmission for a wavelength of 550 nm was measured by using a spectrophotometer (Spectrophotometer UV-3100PC produced by Shimadzu Corporation).

(6) Mechanical Characteristics of Film Substrate

A film sample (1.0 cm×5.0 cm) was prepared, and elastic modulus, tensile rupture stress and tensile rupture ductility of the sample were measured under a condition of a drawing speed of 3 mm/minute by using Tensilon RTM-25 produced by Toyo Baldwin Co., Ltd. The measurement was performed for 3 samples, and an average of the measured values was calculated and used for evaluation (the samples were left overnight at 25° C. and 60% RH before use, chuck gap: 3 cm).

(7) Surface Resistance of Film Substrate

Samples were conditioned for moisture under an environment of 25° C. and 60% RH for 3 hours or more, and initial resistance values (R₀) were measured by using 8009 and RESISTIVITY TEST FIXTURE produced by KEITHLEY and Model 6517A produced by KEITHLEY.

### Example 1

### Preparation of P-1 (Resin of the Present Invention)

A polycarbonate resin (P-1) was obtained by the method described below.

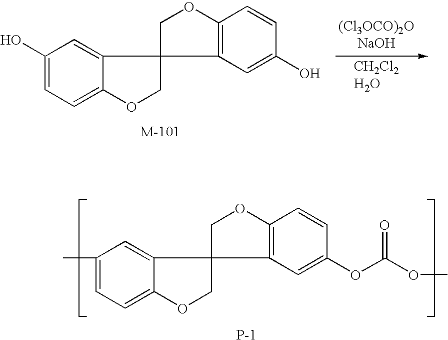

A solution obtained by dissolving 0.2 g sodium hydrosulfite and 17.8 g of sodium hydroxide in 200 mL of water was added to a solution obtained by dissolving 18.58 g of M-101 and 52.7 mg of t-butylphenol in 225 mL of methylene chloride and vigorously stirred. To the mixture, a solution of 6.92 g of triphosgene in 25 mL of methylene chloride was added over 30 minutes. After the addition, the reaction was allowed for further 1 hour, and then 0.2 mL of triethylamine was added to the reaction mixture. After the reaction was allowed further 4 hours, the organic layer was separated by phase separation. Further, the organic layer was washed twice with 300 mL of diluted hydrochloric acid, and methylene chloride was evaporated under reduced pressure. In a volume of 80 mL of methylene chloride was added to the residue for dissolution, the dusts were removed, and the solution was filtered and then slowly poured into 400 mL of methanol. The precipitated resin was collected by filtration, washed with methanol and dried to obtain 13.7 g of a resin (P-1) as white solid. The obtained resin (P-1) had a weight average molecular weight of 92,000 and Tg of 212° C. The result of NMR analysis of the obtained P-1 was as follows.

¹H-NMR (δ in CDCl₃): 4.62 (dd), 6.82 (d), 6.94 (d), 7.02 (dd)

### Example 2

### Preparation of P-2 (Resin of the Present Invention)

A polyester resin (P-2) was obtained by the method described below.

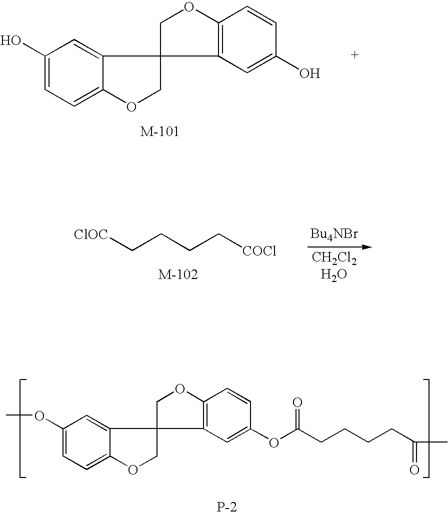

A solution obtained by dissolving 0.06 g of sodium hydrosulfite and 0.56 g of tetrabutylammonium bromide in 75 mL of water was added to a suspension obtained by suspending 5.85 g of M-101 in 40 mL of methylene chloride and vigorously stirred. To the mixture, 21 mL of 2 mol/L aqueous solution of NaOH and a solution of 3.66 g of adipoyl chloride (M-102) in 20 mL of methylene chloride were simultaneously added at room temperature over 1 hour. After the addition, the reaction was allowed for further 6 hours, and then the organic layer was separated by phase separation. Further, the organic layer was washed twice with 300 mL of diluted hydrochloric acid, and methylene chloride was evaporated under reduced pressure. In a volume of 20 mL of methylene chloride was added to the residue for dissolution, the dusts were removed, and the solution was filtered and then slowly poured into 200 mL of methanol. The precipitated resin was collected by filtration, washed with methanol and dried to obtain 6.88 g of a resin (P-2) as white solid. The obtained resin (P-2) had a weight average molecular weight of 46,000 and Tg of 140° C. The result of NMR analysis of the obtained P-2 was as follows.

¹H-NMR (δ in CDCl₃): 1.81 (m), 2.54 (m), 4.62 (dd), 6.79 (dd), 6.81 (d), 6.88 (dd)

### Example 3

### Preparation of P-12 (Resin of the Present Invention)

A polyurethane resin (P-12) was obtained by the method described below. 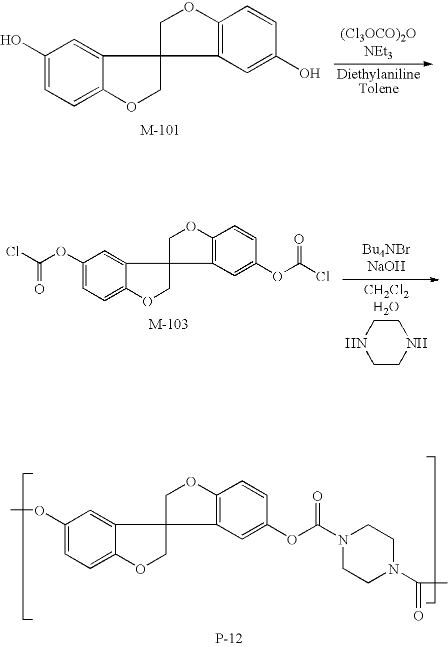
(Preparation of M-103 (Monomer))

In an amount of 38.0 g of triphosgene divided into 6 portions was added portionwise to a suspension obtained by suspending 30.75 g of M-101 and 0.1 mL of triethylamine in 120 mL of toluene under water cooling. To the mixture, 62 mL of diethylaniline was added dropwise under water cooling so that the internal temperature should not exceed 40° C. During the addition, M-101 gradually dissolved, and when about 50 mL of diethylaniline was added dropwise, a salt began to deposit. After the reaction was allowed for further 6 hours, 200 mL of toluene was further added, and the reaction mixture was filtered. The organic layer was separated by phase separation. The filtrate was added with 300 mL of water, and the phases were separated. This procedure was repeated 3 times. The organic layer was dried over anhydrous magnesium sulfate, and then the solvent was evaporated under reduced pressure. The residue was recrystallized from n-hexane/ethyl acetate=6/4, and the precipitated resin was taken by filtration, washed and dried to obtain 28.8 g of a monomer M-103 as white solid.

(Preparation of Polyurethane Resin P-12)

In an amount of 2.15 g of piperazine and 0.35 g of tetrabutylammonium bromide were dissolved in 47 mL of methylene chloride and 94 mL of water and vigorously stirred. To the mixture, 30 mL of 2 mol/L aqueous solution of NaOH and a solution of 9.53 g of the monomer (M-103) in 30 mL of methylene chloride were simultaneously added at room temperature over 1 hour. After the addition, the reaction was allowed for further 6 hours, and then the organic layer was separated by phase separation. Further, the organic layer was washed twice with 300 mL of diluted hydrochloric acid, and methylene chloride was evaporated under reduced pressure. In a volume of 30 mL of methylene chloride was added to the residue for dissolution, the dusts were removed, and the solution was filtered and then slowly poured into 300 mL of methanol. The precipitated resin was collected by filtration, washed with methanol and dried to obtain 7.8 g of a resin (P-12) as white solid. The molecular weight of the obtained resin (P-12) could not measured, because it was not soluble in tetrahydrofuran. The resin (P-12) had Tg of 258° C. The result of NMR analysis of the resin (P-12) was as follows.

¹H-NMR (δ in CDCl₃): 1.60 (s), 3.61 (br.m), 4.62(dd), 6.81 (dd), 6.82 (d), 6.93 (dd)

### Example 4

### Preparation of P-25 (Resin of the Present Invention)

A polyarylate resin (P-25) was obtained by the method described below.

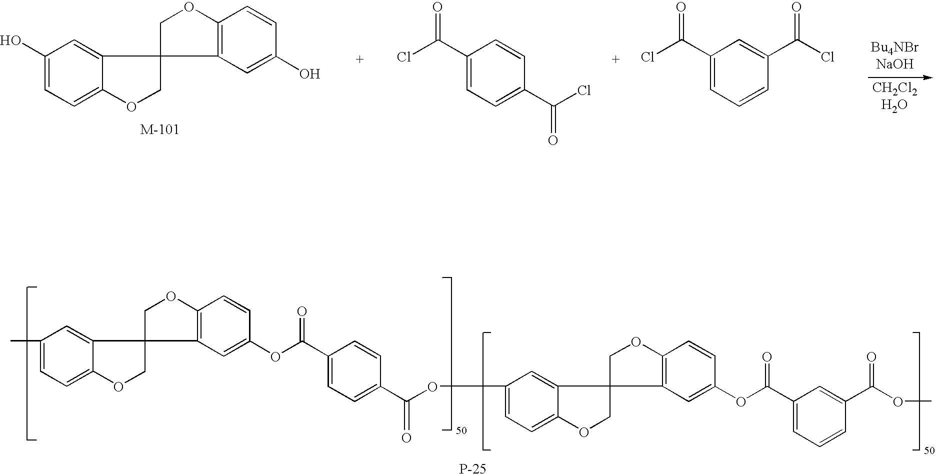

A solution obtained by dissolving 0.09 g of sodium hydrosulfite and 0.42 g of tetrabutylammonium bromide in 113 mL of water was added to a suspension obtained by suspending 7.69 g of M-101 in 98 mL of methylene chloride and vigorously stirred. Then, 31.5 mL of 2 mol/L aqueous solution of NaOH and a solution of 1.52 g of terephthaloyl chloride and 1.52 g of isophthaloyl chloride in 20 mL of methylene chloride were simultaneously added to the mixture at room temperature over 1 hour. After the addition, the reaction was allowed for further 6 hours, and then the organic layer was separated by phase separation. Further, the organic layer was washed twice with 300 mL of diluted hydrochloric acid, and methylene chloride was evaporated under reduced pressure. In a volume of 20 mL of methylene chloride was added to the residue for dissolution, the dusts were removed, and the solution was filtered and then slowly poured into 200 mL of methanol. The precipitated resin was collected by filtration, washed with methanol and dried to obtain 10.5 g of a resin (P-25) as white solid.

The obtained resin had a weight average molecular weight of 50,500 and Tg of 262° C. The result of NMR analysis of the obtained resin (P-25) was as follows.

¹H-NMR (δ in CDCl₃): 4.60 (dd), 6.87 (dd), 6.96 (d), 7.04 (dd), 7.59 (m), 8.21 (d), 8.34 (br.d), 8.86 (br.s)

### Example 5

### Preparation of P-26 (Resin of the Present Invention)

A polyarylate resin (P-26) was obtained by the method described below.

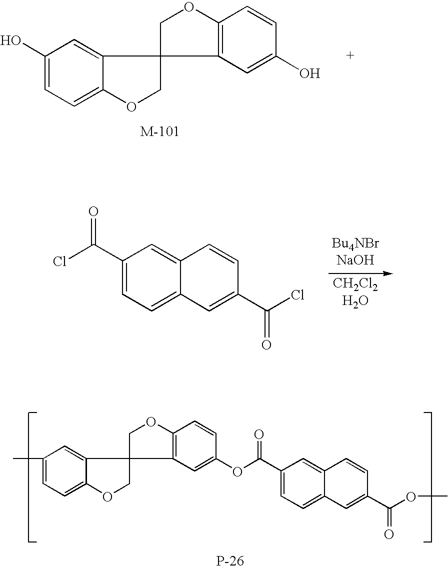

A solution obtained by dissolving 0.09 g of sodium hydrosulfite and 0.42 g of tetrabutylammonium bromide in 113 mL of water was added to a suspension obtained by suspending 7.69 g of M-101 and 7.59 g of 2,6-naphthalenedicarboxylic acid chloride in 98 mL of methylene chloride and vigorously stirred. To the mixture, 31.5 mL of 2 mol/L aqueous solution of NaOH was added at room temperature over 1 hour. After the addition, a resin was precipitated as particles. The reaction was allowed for further 6 hours, and then the precipitated resin was collected by filtration, washed with 100 mL of methylene chloride, 100 mL of methanol, 100 mL of water and 100 mL of methanol in this order and dried to obtain 12.5 g of a resin (P-26) as white solid.

The molecular weight of the obtained resin could not measured, because it was not soluble in tetrahydrofuran. The resin (P-26) had Tg of 281° C.

### Example 6

### Preparation of Resin Films of the Present Invention

The resin compounds P-1, P-2, P-12 and P-25 prepared in Examples 1 to 4 described above and the resin compounds P-4, P-18 and P-22 prepared by a similar method were each dissolved in methylene chloride to prepare 15 to 25 weight % solutions. Each solution was filtered through a 5-μm filter and then cast on a glass substrate by using a doctor blade. After the casting, the solution was dried by heating at 80° C. for 2 hours and at 100° C. for 4 hours, and then the film was delaminated from the glass substrate to prepare Films F-101 to F-107.

In a similar manner, Comparative Film F-108 was prepared by using a commercially available polycarbonate (Panlite L1225Z produced by Teijin Chemicals Ltd.).

Furthermore, comparative films were prepared by using the spirobiindane polycarbonate described in Japanese Patent Laid-open Publication No. 63-314235 (IND-1), the spirobiindane polycarbonate copolymer described in Japanese Patent Laid-open Publication No. 11-263833 (IND-2) and the spirobiindane polycarbonate copolymer described in Japanese Patent Laid-open Publication No. 2000-281888 (IND-3), and they were designated F-109 to F-111, respectively.

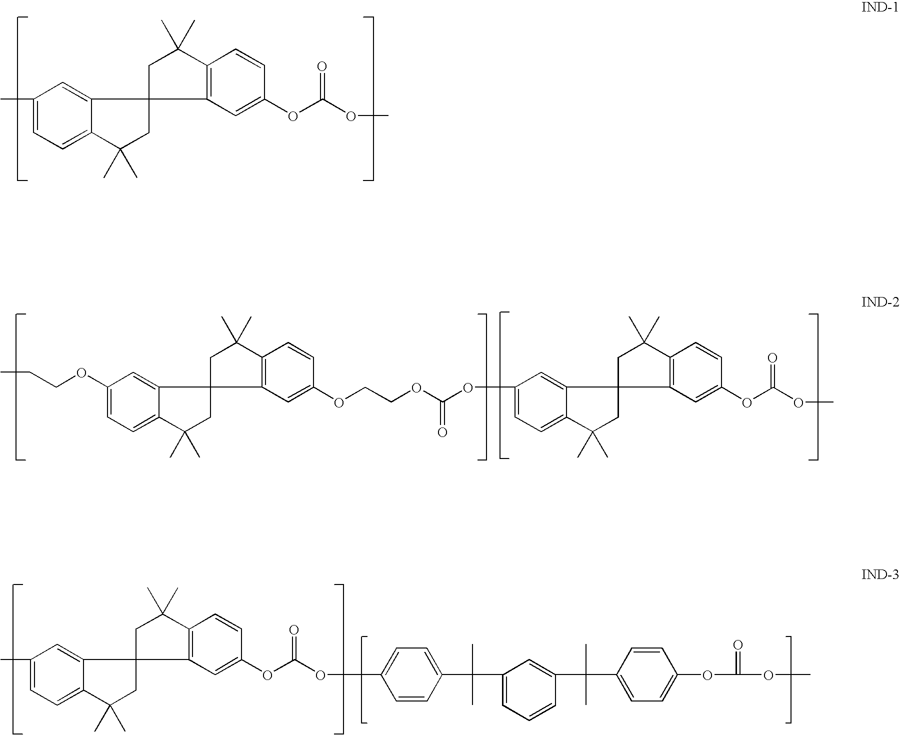

### Example 7

### Evaluation of Optical Properties of Films According to the Present Invention

Thickness and retardation values for a direction along film plane of the films obtained in Example 6 are shown in Table 3.

TABLE 3

| | | Film | | | | |
|---|---|---|---|---|---|---|
| | | thickness | | Haze | | |
| Film | Resin | (μm) | Appearance | (%) | | Note |
| F-101 | P-1 | 100 | Transparent | 0.5 | 2 | Invention |
| F-102 | P-2 | 101 | Transparent | 0.4 | 3 | Invention |
| F-103 | P-4 | 100 | Transparent | 0.4 | 5 | Invention |
| F-104 | P-12 | 100 | Transparent | 0.4 | 2 | Invention |
| F-105 | P-18 | 101 | Transparent | 0.3 | 3 | Invention |
| F-106 | P-22 | 101 | Transparent | 0.3 | 5 | Invention |
| F-107 | P-25 | 100 | Transparent | 0.4 | 4 | Invention |
| F-108 | Panlite | 100 | Transparent | 0.3 | 24 | Comparative |
| F-109 | IND-1 | Film | Transparent | — | — | Comparative |
| | | could not | | | | |
| | | be formed | | | | |
| F-110 | IND-2 | 101 | Transparent | 0.5 | 2 | Comparative |
| F-111 | IND-3 | 100 | Transparent | 0.5 | 10 | Comparative |

Re = Retardation

From the results shown in Table 3, it can be seen that the films prepared with the resin compositions of the present invention had a small retardation (Re) value and thus had superior optical characteristics. The comparative resin IND-1 generated cracks during the film formation (during drying), and therefore a film could not be prepared.

### Example 8

### Evaluation of Mechanical Characteristics of Films According to the Present Invention

Elastic modulus, tensile rupture stress and tensile rupture ductility of the films obtained in Example 6 are shown in Table 4. The data for ZEONOA film (ZF16-100 produced by Nippon Zeon Co., Ltd., F-112, film thickness: 100 μm) are also shown in the table.

TABLE 4

| | | | Tensile | Tensile | |
|---|---|---|---|---|---|
| | | Elastic | rupture | rupture | |
| | | modulus | stress | ductility | |
| Film | Resin | (MPa) | (MPa) | (%) | Note |
| F-101 | P-1 | 1700 | 67 | 6 | Invention |
| F-102 | P-2 | 1600 | 70 | 12.5 | Invention |
| F-103 | P-4 | 1800 | 67 | 15 | Invention |
| F-104 | P-12 | 1600 | 72 | 8 | Invention |
| F-105 | P-18 | 1800 | 63 | 14 | Invention |
| F-106 | P-22 | 1800 | 72 | 9.7 | Invention |
| F-107 | P-25 | 1800 | 61 | 24 | Invention |
| F-108 | Panlite | 2200 | 72 | 140 | Comparative |
| F-109 | IND-1 | Film | Film could | Film | Comparative |
| | | could | not be | could not | |
| | | not be | formed | be formed | |
| | | formed | | | |
| F-110 | IND-2 | 1600 | 49 | 3.5 | Comparative |
| F-111 | IND-3 | Readily | Readily | Readily | Comparative |
| | | ruptured | ruptured | ruptured | |
| F-112 | ZEONOA | 1700 | 69 | 7 | Comparative |

From the results shown in Table 4, it can be seen that although the films produced with the resin compositions of the present invention had elastic modulus and tensile rupture stress and tensile rupture ductility slightly inferior to those of Panlite, they showed a tensile rupture ductility superior to that of the film utilizing the resin F-110 (IND-2) as a comparative example, elastic modulus and tensile rupture stress comparable to those of the commercially available film, ZEONOA (F-112) and tensile rupture ductility comparable or superior to that of ZEONOA, and thus they are films having sufficient mechanical characteristics. Moreover, it can also be seen that, whereas the resin F-109 (IND-1) used as a comparative example generated cracks during film formation (during drying), and thus a film could not prepared from it, the mechanical characteristics, especially brittleness, of the film produced with the polycarbonate F-101 according to the present invention were markedly improved. Furthermore, it can also be seen that, whereas the resin F-111 (IND-3) used as a comparative example was easily ruptured during the preparation of sample for measurement of physical properties, and thus a sample for the measurement by Tensilon could not be prepared from it, the mechanical characteristics, especially brittleness, of the film produced with the polyarylate F-107 according to the present invention were markedly improved.

### Example 9

### Preparation of Substrates for Display Devices According to the Present Invention and Evaluation Thereof

<Gas Barrier Layer>

Gas barrier layers were sputtered on the both surfaces of each of the film substrates shown in Table 4 by the DC magnetron sputtering method at an output of 5 kW under vacuum of 500 Pa in an Ar atmosphere using SiO₂ as a target. The obtained gas barrier layers had a film thickness of 60 nm.

<Transparent Conductive Layer>

A transparent conductive layer consisting of an ITO film having a thickness of 140 nm was provided on one side of the obtained film substrate heated to 100° C. by the DC magnetron sputtering method at an output of 5 kW under vacuum of 0.665 Pa in an Ar atmosphere using ITO (In₂O₃: 95 weight %, SnO₂: 5 weight %) as a target.

<Protective Layer>

The constituents mentioned below were mixed and dissolved at an ordinary temperature to prepare a coating solution, and the coating solution was coated on the barrier layer with a bar coater so as to have a thickness of 3 μm (after drying), heated at 80° C. for 10 minutes and irradiated with an ultraviolet ray.

| | |
|---|---|
| Acrylic resin (acrylic resin | 100 weight parts |
| having Tg of 105° C., molecular | |
| weight of 67000 and acid value | |
| of 2, LR-1065 produced by | |
| Mitsubishi Rayon Co., Ltd.) | |
| Silane coupling agent (N-phenyl- | 1 weight part |
| γ-aminopropyltrimethoxysilane, | |
| KBM-573 produced by Shin-Etsu | |
| Chemical Co., Ltd.) | |
| Butyl acetate | 400 weight parts |

<Evaluation>

Surface resistance of the substrates for display devices obtained as described above was measured by the method described above. Then, the both ends of each sample was adhered so that the ITO layer should be exposed outside to form a cylindrical shape and transported with rolling between two of transport rollers having a diameter of 12 mm at a tension of about 1 N between the rollers at a speed of 30 cm/minute so that the film and rollers should be fully contacted and the film should not slip on the rollers. The samples were conditioned for moisture content in an environment of 25° C. and 60% RH for 8 hours before the test, and the test was performed in a room of the same conditions. After the procedure described above, variation ratio of resistances before and after the bending test was evaluated.

The resistance variation ratio after the bending test was defined to be a value (%) obtained by dividing an absolute value of difference between the resistance value after the bending test (R¹) and the resistance value before the bending test (R₀) with R₀ and represented in percentage.

No significant change was observed in the appearance of the film substrates F-101 to F-107 of the present invention and the comparative film substrate F-108, and they showed a small resistance variation ratio and thus are excellent in resistance variation. On the other hand, the comparative film substrates F-109 and F-111 were brittle, and samples could not be prepared. Although no significant change was observed also in the appearance of the comparative film substrate F-110, it was found that it showed a large variation ratio for resistances before and after the bending test. Further, delamination of the barrier layer was observed for the comparative film substrate F-112.

From the results mentioned above, it can be seen that the substrates for display devices of the present invention have superior mechanical characteristics, i.e., they are unlikely to suffer from resistance variation due to stress, and they are unlikely to generate cracks or the like. It can also be seen that they show superior adhesion to the barrier layer.

### Example 10

### Preparation of Flat Panel Displays of the Present Invention and Evaluation Thereof

<Preparation of Circularly Polarizing Film>

The λ/4 plate described in Japanese Patent Laid-open Publication Nos. 2000-826705 and 2002-131549 was laminated on each of the plastic film substrates F-101 to F-107 of the present invention and the comparative films F-108, F-110 and F-111 on the side opposite to the transparent conductive layer side, and the polarizing plate described in Japanese Patent Laid-open Publication No. 2002-865554 was further laminated thereon to prepare a circularly polarizing plate. The λ/4 plate and the polarizing plate were disposed so that the transmission axis of the polarizing film and the lagging axis of the λ/4 plate should make an angle of 45°.

<Preparation of TN Type Liquid Crystal Display Device>

An oriented polyimide film (SE-7992 produced by Nissan Chemical Industries, Ltd.) was provided on the transparent conductive layer (ITO) side of each of the plastic film substrates of the present invention and comparative substrates as well as an electrode side of a glass substrate provided with an aluminum reflective electrode having fine unevenness on the surface. After the substrates provided with the polyimide film were subjected to a heat treatment at 200° C. for 30 minutes, no increase in resistance and no increase in gas permeability were observed at all for those utilizing the plastic film substrates of the present invention. On the other hand, they increased 2 times or more in all of those utilizing the comparative substrates.

After they were subjected to a rubbing treatment, two substrates (glass substrate and plastic substrate) were laminated via a spacer having a thickness of 1.7 μm so that the oriented films should face each other. The directions of the substrates were adjusted so that the rubbing directions of two of the oriented films should cross at an angle of 110°. Liquid crystal (MLC-6252, Merck Ltd.) was injected into the gap between the substrates to prepare a liquid crystal layer. As described above, TN liquid crystal cells having a twisting angle of 70° and Δnd of 269 nm were prepared. Further, the aforementioned γ/4 plate and polarizing plate were laminated on each plastic film substrate on the side opposite to the ITO side to prepare reflective type liquid crystal display devices.

Good images were obtained with those utilizing the plastics substrates of the present invention. On the other hand, those utilizing the comparative substrates generated black spot defects (image portions became fine black spots, and thus images were not displayed) due to reduction of gas barrier property and color drift due to cracks in the conductive layer.

<Production of STN Type Liquid Crystal Display Devices>

An oriented polyimide film (SE-7992 produced by Nissan Chemical Industries, Ltd.) was provided on each of the plastic film substrates of the present invention F-101 to F-107, comparative films F-108, F-110 and F-111 and a glass substrate laminated with an ITO layer on the transparent electrode (ITO) layer side. After the substrates provided with the polyimide film were subjected to a heat treatment at 200° C. for 30 minutes, no increase in resistance and no increase in gas permeability were observed at all for those utilizing the plastic film substrates of the present invention. On the other hand, they increased 2 times or more in all of those utilizing the comparative substrates.

<Preparation of Organic EL Devices>

By using the film substrates of the present invention, organic EL devices having a structure comprising a protective cellulose triacetate (outermost surface had a antireflection function), the aforementioned circularly polarizing plate (the ITO layer of the plastic substrate of the present invention was disposed on the organic EL device side), organic EL device and reflective electrode from the observer side were prepared according to Japanese Patent Laid-open Publication No. 2000-267097. Those according to the present invention showed good performance.

<Preparation of TFT Arrays>

TFT arrays were prepared by using the plastic film substrates of the present invention according to the method described in International Patent Publication in Japanese (Kohyo) No. 10-512104. Even when the substrates were exposed to dimethyl sulfoxide as a solvent for removing resist or developer for photolithography, they do not show changes such as getting cloudy during the preparation process.

### Example 11

### Preparation of Plastic Lenses According to the Present Invention and Evaluation Thereof

The resin P-1 of the present invention was dried 80° C. for 5 hours under reduced pressure and used to experimentally prepare a convex lens having a spherical surface, diameter of 30 mm and thickness of 1 to 3 mm by using an injection molding machine at a molding temperature of 300° C. In a similar manner, a plastic lens according to the present invention was prepared from the resin P-2 of the present invention, and a comparative plastic lens was prepared from a commercially available polycarbonate (Panlite AD5503 produced by Teijin Chemicals Ltd.) as a comparative resin. These resins were molded at a molding temperature of 280° C.

When they were observed under crossed nicols of the polarizing plate, it was confirmed that the plastic lens obtained from the commercially available polycarbonate showed large optical strain, and the strain is especially large around a gate. In contrast, it was confirmed that the plastic lenses obtained from the resins of the present invention showed little optical strain, in particular, even around a gate, and it was found that the resins of the present invention provided plastic lenses having superior optical characteristics.

Since the resin composition of the present invention has superior heat resistance, optical characteristics, mechanical characteristics etc., it can be utilized for a plastic film substrate, various optical components such as transparent conductive film substrate, TFT substrate, substrate for liquid crystal display, substrate for organic EL display, substrate for electronic paper, substrate for solar battery, optical disk substrate, optical waveguide, optical fiber, lens and touch panel, and flat panel display.

The present disclosure relates to the subject matter contained in Japanese Patent Application No. 036735/2004 filed on Feb. 13, 2004, which is expressly incorporated herein by reference in its entirety.

The foregoing description of preferred embodiments of the invention has been presented for purposes of illustration and description, and is not intended to be exhaustive or to limit the invention to the precise form disclosed. The description was selected to best explain the principles of the invention and their practical application to enable others skilled in the art to best utilize the invention in various embodiments and various modifications as are suited to the particular use contemplated. It is intended that the scope of the invention not be limited by the specification, but be defined claims set forth below.

1. A resin composition containing a polymer comprising a chemical structure represented by the following formula (1) in a main chain of the polymer: 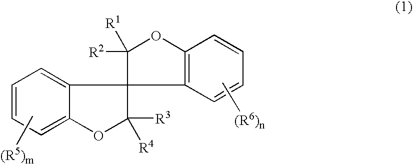
wherein, in the formula (1), R¹ to R⁴ independently represent hydrogen atom or a substituent, R⁵ and R⁶ independently represent a substituent, m and n represent an integer of 0 to 4, and when m and/or n is 2 or larger, R⁵ and/or R⁶ may be the same or different, and R⁵ or R⁶ may bond to each other to form a 5- to 7-membered ring.

2. The resin composition according to claim 1, wherein R¹ to R⁴ in the formula (1) represent hydrogen atom.

3. The resin composition according to claim 1, wherein m and n in the formula (1) independently represent 0 or 1.

4. The resin composition according to claim 1, which has a glass transition temperature of 200° C. or higher.

5. The resin composition according to claim 1, wherein the content of the structure represented by the formula (1) is 20 to 100 weight %, relative to the total weight of the resin composition.

6. The resin composition according to claim 1, which is polycarbonate, polyester, polyarylate, polyester carbonate, polysulfone, polyurethane, polyamide, polyimide or polyamidimide.

7. The resin composition according to claim 1, which is polycarbonate, polyester, polyarylate or polyurethane.

8. The resin composition according to claim 1, which has a weight-average molecular weight of 10,000 to 300,000.

9. The resin composition according to claim 1, which contains a polymer comprising a repeating structural unit represented by the following formula (2): 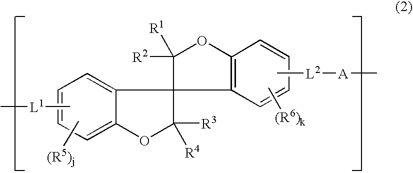
wherein, in the formula (2), R¹ to R⁴ independently represent hydrogen atom or a substituent, R⁵ and R⁶ independently represent a substituent, L¹ and L² represent a single bond or a divalent bridging group, j and k represent an integer of 0 to 3, when j and/or k is 2 or larger, R⁵ and/or R⁶ may be the same or different, and R⁵ or R⁶ may bond to each other to form a 5- to 7-membered ring, L¹ and R⁵ and/or L² and R⁶ may bond to each other to form a 5- to 7-membered ring, and A represents at least one kind of group selected from divalent bridging groups represented by the formulas (3) to (9): 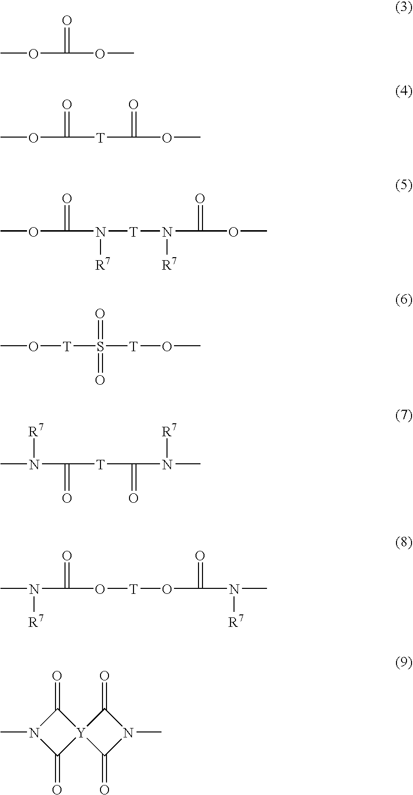
wherein, in the formulas (3) to (9), T represents a divalent organic group, Y represents a tetravalent organic group, R⁷ independently represents hydrogen atom or a substituent, and two of R⁷ may bond to each other to form a ring, and wherein the polymer may contain two or more kinds of different repeating units represented by the formula (2).

10. The resin composition according to claim 9, which contains a polymer comprising a repeating structural unit represented by the following formula (2′): 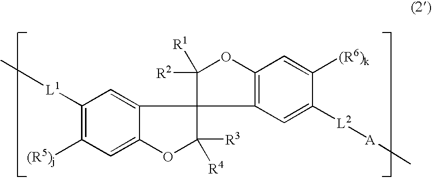
wherein R¹ to R⁶, L¹, L², j, k and A are as defined in claim 9.

11. The resin composition according to claim 9, wherein R⁵ and R⁶ in the formula (2) independently represent one kind of group selected from the group consisting of a halogen atom, an aliphatic group having 1 to 10 carbon atoms, an aromatic group having 6 to 20 carbon atoms, an alkoxyl group having 1 to 10 carbon atoms and an acylamino group having 1 to 10 carbon atoms.

12. The resin composition according to claim 9, wherein L¹ and L² in the formula (2) represent a single bond.

13. The resin composition according to claim 9, wherein the polymer further contains a repeating structural unit represented by the following formula (10): [symbol]
B-A [symbol] (10)
wherein, in the formula (10), A represents at least one kind of group selected from divalent bridging groups represented by the formulas (3) to (9), and B represents a divalent organic group, and molar percentage q of the repeating structural units represented by the formula (10) relative to the total molar number of the repeating structural units represented by the formula (2) and the formula (10) satisfies the equation of 0<q<=50 mol %.

14. An optical component utilizing the resin composition according to claim 1.

15. A plastic lens utilizing the resin composition according to claim 1.

16. A plastic film substrate utilizing the resin composition according to claim 1.

17. A transparent conductive film substrate utilizing the plastic film substrate according to claim 16.

18. A flat panel display utilizing the transparent conductive film substrate according to claim 17.

19. A flat panel display according to claim 18, which comprises a liquid crystal panel as a display device.

20. A flat panel display according to claim 18, which comprises an organic electroluminescence panel as a display device.
